SEQUENCE LISTING (6 sequences)

SEQ ID NO: 1 - protein, 1081 aa, Felis catus
MAFYSCCLILLAITWCTSAYGPDQRAQKKGDIILGGLFPIHFGVAAKDQDLKSRPESVECIRYNFRGFRWLQAMIFAIEEINSSPVLLPNMTLGYRIFDTCNTVSKALEATLSFVAQNKIDSLNLDEFCNCSEHIPSTIAVVGATGSGISTAVANLLGLFYIPQVSYASSSRLLSNKNQFKSFLRTIPNDEHQATAMADIIEYFRWNWVGTIAADDDYGRPGIEKFREEAEERDICIDFSELISQYSDEEEIQQVVEVIQNSTAKVIVVFSSGPDLEPLIKEIVRRNITGRIWLASEAWASSSLIAMPEYFHVVGGTIGFALKAGQIPGFREFLQKVHPRKSVHNGFAKEFWEETFNCHLQEGAKGPLALDTFLRGHEEGGGRISNSSTALRPLCTGDENISSVETPYMDYTHLRISYNVYLAVYSIAHALQDIYTCLPGRGLFTNGSCADIKKVEAWQVLKHLRHLNFTNNMGEQVTFDECGDLVGNYSIINWHLSPEDGSIVFKEVGYYNVYAKKGERLFINEEKILWSGFSREVPFSNCSRDCLAGTRKGIIEGEPTCCFECVECPDGEYSDETDASACDKCPDDFWSNENHTSCIAKEIEFLSWTEPFGIALTLFAVLGIFLTAFVLGVFLKFRNTPIVKATNRELSYLLLFSLLCCFSSSLFFIGEPQDWTCRLRQPAFGISFVLCISCILVKTNRVLLVFEAKIPTSFHRKWWGLNLQFLLVFLCTFMQIVICVIWLYTAPPSSYRNHELEDEIIFITCHEGSLMALGFLIGYTCLLAAICFFFAFKSRKLPENFNEAKFITFSMLIFFIVWISFIPAYASTYGKFVSAVEVIAILAASFGLLACIFFNKVYIILFKPSRNTIEEVRCSTAAHAFKVAARATLRRSNVSRKRSSSLGGSTGSTPSSSISSKSNSEDPFPQPERQKQQQPLALTQQEQQPQPQQPSSLQQQPQPQPQPRCKQKVIFGSGTVTFSLSFDEPQKSAMAHRNSMHQNSLEAQKSNETLTRHQALLPLQCGETDSELSAQERGLQGPVDGDFRPEMEDPEEMSPALVVSSSQSFVISGGGSTVTENILHS

SEQ ID NO: 2 - DNA, 3243 bp, Felis catus
atggcattttatagctgctgtttgatcctcttggcaattacctggtgcacttctgcctatgggcctgaccaacgagctcagaagaaaggggacattatcctcggggggctctttcctattcattttggagtagcagccaaagatcaagatctaaagtcaaggccagagtctgtggaatgtatcaggtataatttccgtgggtttcgctggttacaagcaatgatatttgccatcgaggaaataaacagcagcccagtccttcttcccaacatgacactgggatacaggatatttgacacttgcaacactgtttctaaagccttggaggccactctgagttttgtggcacaaaataaaattgattctctgaacctcgacgagttctgcaactgctcagagcatatcccctctactatcgctgtggtgggagcaactggttcgggcatctccacagcggtggcaaacctgctgggcctcttctatattccccaggtcagctatgcctcctccagcagactcctcagcaacaaaaatcagttcaagtcctttctccgtaccatccccaatgatgaacaccaggccactgccatggcagacattatcgagtatttccgctggaactgggtgggcacaattgctgctgatgatgactacggccggccagggattgagaagtttcgagaggaagctgaggagagggacatctgcatcgacttcagtgaactcatctcccagtattctgatgaagaagagatccagcaagtggtggaggtgatccagaattccacagccaaagtcattgttgttttctctagtggcccagaccttgaaccccttatcaaggagattgtccggcgtaatatcacagggaggatctggctggccagcgaggcctgggccagctcttccttgattgccatgcccgagtacttccatgtggttggaggcaccattggattcgctctgaaggctggacagatcccaggtttccgggaattcctgcagaaagtccatcccagaaagtctgtccacaatggttttgccaaggagttttgggaagaaacctttaactgccacctccaagaaggtgctaaaggacctttagcactggacactttcctgagaggtcatgaagaaggtggtggcaggataagcaatagctccactgccttgcgacctctctgtacaggggacgagaacatcagcagcgtggagaccccttacatggattatacacatttacggatatcctacaatgtctacttagcggtctattccattgctcatgccctgcaagatatatatacatgcttacctggaagagggctcttcaccaatggttcctgcgcagatatcaagaaggttgaggcttggcaggtcctgaagcacctacggcacctaaactttaccaacaatatgggggagcaggtgactttcgatgaatgtggggacctggtggggaactattccatcatcaactggcacctctctccagaggatggctccatagtgtttaaggaagtcggatattacaacgtctatgccaagaaaggagaaaggctcttcatcaatgaggagaaaatcctgtggagtggattctccagggaggtacctttctccaactgcagtcgagactgcctggcagggacccggaaaggaatcattgagggggagcccacctgctgctttgagtgtgtggaatgtcctgatggggagtacagtgatgaaacagatgcaagtgcctgtgacaagtgccccgatgacttctggtccaatgagaaccacacttcttgcattgccaaggagattgagtttctgtcctggacggagccctttgggattgcactcactctctttgctgtgctgggcattttcctgacagccttcgtgctgggtgtcttcctcaagttccgtaacacacccattgtcaaggctaccaatcgagagctctcctacctcctcctcttctccttgctctgctgcttctccagctccctgttcttcattggtgagccccaggactggacatgccgcctgcgccagccagcctttggcatcagcttcgtgctctgcatatcatgcatcctagtgaaaaccaaccgtgtcctcctggtgtttgaggccaagatccccacgagcttccaccgcaagtggtgggggctcaacctgcagttcctgctggtcttcctctgcaccttcatgcagattgtcatctgtgtgatctggctctacactgcaccaccctcaagctaccgcaaccacgagctggaggatgagatcatctttatcacatgccacgagggctcgctcatggccctgggcttcttaattggctacacctgcctactggctgccatctgcttcttctttgccttcaagtcccggaagctgccagagaatttcaatgaagccaagttcatcaccttcagcatgctcatcttcttcatcgtctggatctccttcatcccagcctatgccagcacctatggcaagtttgtctctgccgtggaagtgatcgccatcctggcagccagctttggcttgctggcctgcatcttcttcaacaaggtctacatcatcctcttcaagccatcacgtaacaccatcgaggaggtgcgctgcagcactgctgcccatgctttcaaagtagcagcccgggccacgctgcgccgcagcaacgtctctcgcaagcggtccagcagccttgggggctccacgggatccacaccctcttcctccatcagcagtaagagcaacagtgaagaccccttcccacagcccgagaggcaaaagcagcagcagccactggccctgacccaacaagagcagcagccgcagccacagcagccctcgtccctacagcagcagccacagccacagccacagcccagatgcaagcagaaagtcattttcggcagtggcacagtcaccttctcactgagctttgatgagcctcagaagagtgccatggctcacaggaattctatgcaccagaactccctggaggcccagaaaagcaatgagaccctcaccagacaccaggcattactcccactacagtgcggggagacagactcagaactgagtgcccaggagagaggtcttcaagggcctgtagatggggacttccgaccagagatggaggaccctgaagagatgtccccagcgcttgtagtgtccagttcacaaagctttgtcatcagtggtggtggcagcactgtcacagaaaatatactgcattca

SEQ ID NO: 3 - protein, 1075 aa, Canis familiaris
MAFHSCSLILLAITWCTSAYGPDQRAQKKGDIILGGLFPIHFGVAAKDQDLKSRPESVECIRYNFRGFRWLQAMIFAIEEINSSPALLPNMTLGYRIFDTCNTVSKALEATLSFVAQNKIDSLNLDEFCNCSEHIPSTIAVVGATGSGISTAVANLLGLFYIPQVSYASSSRLLSNKNQFKSFLRTIPNDEHQATAMADIIEYFRWNWVGTIAADDDYGRPGIEKFREEAEERDICIDFSELISQYSDEEEIQQVVEVIQNSTAKVIVVFSSGPDLEPLIKEIVRRNITGRIWLASEAWASSSLIAMPEYFHVVGGTIGFALKAGQIPGFREFLQKVHPRKSVHNGFAKEFWEETFNCHLQEGAKGPLSMDTFLRGHEEGGGRISNSSTAFRPLCTGDENISSVETPYMDYTHLRISYNVYLAVYSIAHALQDIYTCLPGRGLFTNGSCADIKKVEAWQVLKHLRHLNFTNNMGEQVTFDECGDLMGNYSIINWHLSPEDGSIVFKEVGYYNVYAKKGERLFINEEKILWSGFSREMPFSNCSRDCLAGTRKGIIEGEPTCCFECVECPDGEYSDETDASACDKCPDDFWSNENHTSCIAKEIEFLSWTEPFGIALTLFAVLGIFLTAFVLGVFIKFRNTPIVKATNRELSYLLLFSLLCCFSSSLFFIGEPQDWTCRLRQPAFGISFVLCISCILVKTNRVLLVFEAKIPTSFHRKWWGLNLQFLLVFLCTFMQIVICVIWLYTAPPSSYRNHELEDEIIFITCHEGSLMALGFLIGYTCLLAAICFFFAFKSRKLPENFNEAKFITFSMLIFFIVWISFIPAYASTYGKFVSAVEVIAILAASFGLLACIFFNKVYIILFKPSRNTIEEVRCSTAAHAFKVAARATLRRSNVSRKRSGSLGGSTGSTPSSSISSKSNSEDPFPQPERQKQQQPLALTQREQQPPQPLTLPPQPQPRCKQKVIFGSGTVTFSLSFDEPQKSAAAPRNSTLQHSLEAQRSPEPPARPQALLPPQGGDTDAELPAQEPGLQGPGGADRRPEMRDPEELSPALVVSSSQSFVISGGGSTVTENILHS

SEQ ID NO: 4 - DNA, 3228 bp, Canis familiaris
atggcatttcacagctgctctttgatcctcttggcaatcacctggtgcacttctgcctatgggcctgaccaacgagcccagaagaaaggggacattatccttggggggctctttcctattcattttggagtagcagccaaagatcaagatctaaagtcaaggccggagtctgtggaatgtatcaggtacaatttccgcgggtttcgttggttacaagcaatgatatttgccatcgaggaaataaacagcagcccagcccttcttccaaacatgacactgggatacagaatatttgacacttgcaacaccgtttctaaagccttggaggccactctgagttttgtggcacagaataaaattgattctctgaaccttgacgagttctgcaactgctcagagcatatcccctctactatcgctgtggtgggagcaactggctcgggcatctccacggctgtggcaaacctgctgggcctcttctacatcccccaggtcagctatgcctcctccagcagactcctcagcaataagaatcagttcaagtccttcctccgtaccatccccaatgatgaacaccaggccactgccatggcagacattattgagtatttccgctggaactgggtgggcaccattgcagctgatgatgactacggccggccagggattgagaagttccgagaggaagcagaggagagggacatctgcatcgacttcagtgaactcatctcccagtactctgatgaggaagagattcagcaagtggtagaggtgatccagaattccacagccaaagtcattgttgttttctccagtggcccagaccttgaacccctcatcaaggagatcgtccggcgaaatatcacaggaaggatttggctggccagtgaggcctgggccagctcttccttgattgccatgcccgagtacttccatgtggttggaggtaccattggattcgctttgaaggctgggcagatcccaggtttccgggaattcctgcagaaagtccatcccagaaagtctgtccacaacggttttgccaaggagttttgggaagaaacatttaactgccacctccaagaaggtgctaaagggcctttatccatggacactttcctgagaggccacgaagaaggtggtggcaggataagcaacagctccactgccttccgacctctttgcacaggagatgagaacatcagtagtgtggagaccccttatatggattatacacacttacggatatcctacaacgtctacttagcagtctattccattgctcatgccctgcaagatatatatacatgcttacctgggagagggctcttcaccaacggttcctgtgctgatattaagaaggttgaggcttggcaggtcttgaagcacctacggcacctaaactttaccaacaatatgggggagcaagtgactttcgatgaatgtggtgacctgatggggaactattccatcatcaactggcacctctctccagaggatggctccatagtgtttaaggaagtcggatattacaatgtctatgccaagaaaggagaaagactcttcatcaatgaggagaaaatcctgtggagtgggttctccagggagatgccattttccaactgcagccgagactgcctggcagggaccaggaaaggaatcattgagggggagcctacctgctgctttgagtgtgtggagtgccccgacggggagtacagtgatgaaacagatgcaagtgcctgtgacaagtgccccgatgacttctggtccaatgaaaaccacacttcgtgcattgccaaagagattgagtttctgtcctggacagagccctttgggattgcactcaccctctttgctgtgctgggcattttcctgacagctttcgtgctgggggtcttcatcaagttccgtaacacgcccatcgtcaaggccaccaaccgagagctctcgtacctcctcctcttctccttgctgtgctgcttctccagctccctgttcttcattggcgagccccaggactggacctgccgcctgcgccagccggcctttggcatcagcttcgtgctctgcatatcatgcatcctggtgaaaaccaaccgtgtcctcctggtgtttgaggccaagatccccacaagcttccaccgcaagtggtgggggctcaacctgcagttcctgctggtcttcctctgcaccttcatgcagattgtcatctgtgtgatctggctctacacggcgcctccctccagctaccgcaaccatgagctggaggacgagatcatcttcatcacatgccacgagggctccctgatggccctgggcttcctgattggctacacctgcctgctggctgccatctgcttcttctttgccttcaagtcccggaagctgccggagaacttcaacgaggccaagttcatcaccttcagcatgctcatcttcttcatcgtctggatctccttcattccagcctacgccagcacctacggcaagtttgtctctgccgtggaagtgatcgccatcctggccgccagctttggcctcctggcctgcatcttcttcaacaaggtgtacatcatcctcttcaagccgtcccgcaacaccatcgaggaggtgcgctgcagcaccgcggctcacgctttcaaggtcgcggcccgcgccacgctgcgccgcagcaacgtctcccgcaagcggtccggcagcctggggggctccacgggctccacgccctcctcctccatcagcagcaagagcaacagtgaagaccccttcccgcagcccgagaggcagaagcagcagcagcccctggccctgacccagcgggagcagcagccgccgcagcccttgaccttgccgccgcagccgcagcccaggtgcaagcagaaggtcatcttcggcagtggcaccgtcaccttctcgctgagctttgacgagccgcagaagagcgccgcggccccccgcaattccacgctgcagcactccctggaggcccagcggagccccgagccccccgccagaccccaggcgttactgccgccgcagggcggagacacagacgcggagctgccggcccaggagccgggcctgcagggccccgggggtgcggaccgccgcccggagatgcgagaccccgaagagctgtccccagccctggtggtgtccagctcacaaagctttgtcatcagcggcggaggcagcacggtcacggaaaacatactgcattcgtaa

SEQ ID NO: 5 - protein, 1078 aa, Homo sapiens
MAFYSCCWVLLALTWHTSAYGPDQRAQKKGDIILGGLFPIHFGVAAKDQDLKSRPESVECIRYNFRGFRWLQAMIFAIEEINSSPALLPNLTLGYRIFDTCNTVSKALEATLSFVAQNKIDSLNLDEFCNCSEHIPSTIAVVGATGSGVSTAVANLLGLFYIPQVSYASSSRLLSNKNQFKSFLRTIPNDEHQATAMADIIEYFRWNWVGTIAADDDYGRPGIEKFREEAEERDICIDFSELISQYSDEEEIQHVVEVIQNSTAKVIVVFSSGPDLEPLIKEIVRRNITGKIWLASEAWASSSLIAMPQYFHVVGGTIGFALKAGQIPGFREFLKKVHPRKSVHNGFAKEFWEETFNCHLQEGAKGPLPVDTFLRGHEESGDRFSNSSTAFRPLCTGDENISSVETPYIDYTHLRISYNVYLAVYSIAHALQDIYTCLPGRGLFTNGSCADIKKVEAWQVLKHLRHLNFTNNMGEQVTFDECGDLVGNYSIINWHLSPEDGSIVFKEVGYYNVYAKKGERLFINEEKILWSGFSREVPFSNCSRDCLAGTRKGIIEGEPTCCFECVECPDGEYSDETDASACNKCPDDFWSNENHTSCIAKEIEFLSWTEPFGIALTLFAVLGIFLTAFVLGVFIKFRNTPIVKATNRELSYLLLFSLLCCFSSSLFFIGEPQDWTCRLRQPAFGISFVLCISCILVKTNRVLLVFEAKIPTSFHRKWWGLNLQFLLVFLCTFMQIVICVIWLYTAPPSSYRNQELEDEIIFITCHEGSLMALGFLIGYTCLLAAICFFFAFKSRKLPENFNEAKFITFSMLIFFIVWISFIPAYASTYGKFVSAVEVIAILAASFGLLACIFFNKIYIILFKPSRNTIEEVRCSTAAHAFKVAARATLRRSNVSRKRSSSLGGSTGSTPSSSISSKSNSEDPFPQPERQKQQQPLALTQQEQQQQPLTLPQQQRSQQQPRCKQKVIFGSGTVTFSLSFDEPQKNAMAHRNSTHQNSLEAQKSSDTLTRHEPLLPLQCGETDLDLTVQETGLQGPVGGDQRPEVEDPEELSPALVVSSSQSFVISGGGSTVTENVVNS

SEQ ID NO: 6 - DNA, 3237 bp, Homo sapiens
atggcattttatagctgctgctgggtcctcttggcactcacctggcacacctctgcctacgggccagaccagcgagcccaaaagaagggggacattatccttggggggctctttcctattcattttggagtagcagctaaagatcaagatctcaaatcaaggccggagtctgtggaatgtatcaggtataatttccgtgggtttcgctggttacaggctatgatatttgccatagaggagataaacagcagcccagcccttcttcccaacttgacgctgggatacaggatatttgacacttgcaacaccgtttctaaggccttggaagccaccctgagttttgttgctcaaaacaaaattgattctttgaaccttgatgagttctgcaactgctcagagcacattccctctacgattgctgtggtgggagcaactggctcaggcgtctccacggcagtggcaaatctgctggggctcttctacattccccaggtcagttatgcctcctccagcagactcctcagcaacaagaatcaattcaagtctttcctccgaaccatccccaatgatgagcaccaggccactgccatggcagacatcatcgagtatttccgctggaactgggtgggcacaattgcagctgatgacgactatgggcggccggggattgagaaattccgagaggaagctgaggaaagggatatctgcatcgacttcagtgaactcatctcccagtactctgatgaggaagagatccagcatgtggtagaggtgattcaaaattccacggccaaagtcatcgtggttttctccagtggcccagatcttgagcccctcatcaaggagattgtccggcgcaatatcacgggcaagatctggctggccagcgaggcctgggccagctcctccctgatcgccatgcctcagtacttccacgtggttggcggcaccattggattcgctctgaaggctgggcagatcccaggcttccgggaattcctgaagaaggtccatcccaggaagtctgtccacaatggttttgccaaggagttttgggaagaaacatttaactgccacctccaagaaggtgcaaaaggacctttacctgtggacacctttctgagaggtcacgaagaaagtggcgacaggtttagcaacagctcgacagccttccgacccctctgtacaggggatgagaacatcagcagtgtcgagaccccttacatagattacacgcatttacggatatcctacaatgtgtacttagcagtctactccattgcccacgccttgcaagatatatatacctgcttacctgggagagggctcttcaccaatggctcctgtgcagacatcaagaaagttgaggcgtggcaggtcctgaagcacctacggcatctaaactttacaaacaatatgggggagcaggtgacctttgatgagtgtggtgacctggtggggaactattccatcatcaactggcacctctccccagaggatggctccatcgtgtttaaggaagtcgggtattacaacgtctatgccaagaagggagaaagactcttcatcaacgaggagaaaatcctgtggagtgggttctccagggaggtgcccttctccaactgcagccgagactgcctggcagggaccaggaaagggatcattgagggggagcccacctgctgctttgagtgtgtggagtgtcctgatggggagtatagtgatgagacagatgccagtgcctgtaacaagtgcccagatgacttctggtccaatgagaaccacacctcctgcattgccaaggagatcgagtttctgtcgtggacggagccctttgggatcgcactcaccctctttgccgtgctgggcattttcctgacagcctttgtgctgggtgtgtttatcaagttccgcaacacacccattgtcaaggccaccaaccgagagctctcctacctcctcctcttctccctgctctgctgcttctccagctccctgttcttcatcggggagccccaggactggacgtgccgcctgcgccagccggcctttggcatcagcttcgtgctctgcatctcatgcatcctggtgaaaaccaaccgtgtcctcctggtgtttgaggccaagatccccaccagcttccaccgcaagtggtgggggctcaacctgcagttcctgctggttttcctctgcaccttcatgcagattgtcatctgtgtgatctggctctacaccgcgcccccgtcaagctaccgcaaccaggagctggaggatgagatcatcttcatcacgtgccacgagggctccctcatggccctgggcttcctgatcggctacacctgcctgctggctgccatctgcttcttctttgccttcaagtcccggaagctgccggagaacttcaatgaagccaagttcatcaccttcagcatgctcatcttcttcatcgtctggatctccttcattccagcctatgccagcacctatggcaagtttgtctctgccgtagaggtgattgccatcctggcagccagctttggcttgctggcgtgcatcttcttcaacaagatctacatcattctcttcaagccatcccgcaacaccatcgaggaggtgcgttgcagcaccgcagctcacgctttcaaggtggctgcccgggccacgctgcgccgcagcaacgtctcccgcaagcggtccagcagccttggaggctccacgggatccaccccctcctcctccatcagcagcaagagcaacagcgaagacccattcccacagcccgagaggcagaagcagcagcagccgctggccctaacccagcaagagcagcagcagcagcccctgaccctcccacagcagcaacgatctcagcagcagcccagatgcaagcagaaggtcatctttggcagcggcacggtcaccttctcactgagctttgatgagcctcagaagaacgccatggcccacaggaattctacgcaccagaactccctggaggcccagaaaagcagcgatacgctgacccgacacgagccattactcccgctgcagtgcggggaaacggacttagatctgaccgtccaggaaacaggtctgcaaggacctgtgggtggagaccagcggccagaggtggaggaccctgaagagttgtccccagcacttgtagtgtccagttcacagagctttgtcatcagtggtggaggcagcactgttacagaaaacgtagtgaattcataa

(19) United States
(12) Patent Application Publication
(10) Pub. No.: US 2022/0256889 A1
(43) Pub. Date: Aug. 18, 2022

(54) PEPTIDES THAT MODULATE CALCIUM-SENSING RECEPTOR ACTIVITY FOR MODULATING KOKUMI TASTE AND PET FOOD PRODUCTS CONTAINING THE SAME

(71) Applicant: MARS, INCORPORATED, McLean, VA (US)

(72) Inventors: Scott McGrane, Leicestershire (GB); Anni Laffitte, Leicestershire (GB); Rajiv Perumal, Bolton (CA)

(73) Assignee: MARS, INCORPORATED, McLean, VA (US)

(21) Appl. No.: 17/434,797

(22) PCT Filed: Mar. 5, 2020
(86) PCT No.: PCT/US2020/021244

§ 371 Date: Aug. 30, 2021

Related U.S. Application Data
(60) Provisional application No. 62/814,082, filed on Mar. 5, 2019.

(51) Int. Cl. A23K 20/147; A23K 50/42; A23K 50/48

(52) U.S. Cl. CPC A23K 20/147; A23K 50/48; A23K 50/42

(57) ABSTRACT

A flavor composition comprising at least one peptide that activates or increases the activity of a calcium-sensing receptor that can be used to enhance the kokumi taste and/or palatability of pet food products is described herein. Also disclosed herein are methods for identifying said peptides.

### CROSS REFERENCE TO RELATED APPLICATIONS

This application is a U.S. National Stage Patent Application under 35 U.S.C. § 371 of International Patent Application No. PCT/US2020/021244, filed on Mar. 5, 2020, which claims the benefit of priority of U.S. Provisional Patent Application No. 62/814,082, filed on Mar. 5, 2019, the contents of each of which are hereby incorporated by reference in their entirety, and to each of which priority is claimed.

### SEQUENCE LISTINGS

The specification further incorporates by reference the Sequence Listing submitted herewith via EFS on Mar. 18, 2022. Pursuant to 37 C.F.R. § 1.52(e)(5), the Sequence Listing text file, identified as 0692690477SL.txt, is 43,291 bytes and was created on Nov. 15, 2021. The Sequence Listing, electronically filed herewith, does not extend beyond the scope of the specification and thus does not contain new matter.

### FIELD

The presently disclosed subject matter relates to flavor compositions that include at least one peptide that interacts with a calcium-sensing receptor (CaSR) for modulating kokumi taste. The flavor compositions can be used to enhance or modify the palatability, taste and/or flavor of pet food products. The flavor compositions can include combinations of compounds, and can either be added to pet food products in various delivery system formats or be generated during a manufacturing process of a pet food product.

### BACKGROUND

Taste profiles for edible compositions include basic tastes such as sweet, salt, bitter, sour, umami and kokumi. Chemical compounds that elicit these tastes are often referred to as tastants. Without being bound by theory, it is hypothesized that tastants are sensed by taste receptors in the mouth and throat which transmit signals to the brain where the tastants and resulting taste profiles are registered. Taste receptors include the calcium-sensing receptor (CaSR), which is a G-protein coupled receptor (GPCR) that detects changes in extracellular calcium levels and a close relative to the T1R1, T1R2 and T1R3 receptors, i.e., the sweet and umami receptors. The calcium-sensing receptor has been shown to function as a receptor for kokumi taste.

Pet food manufacturers have a long-standing desire to provide pet food products that have high nutritional value. In addition, and with particular regard to cat and dog foods, pet food manufacturers desire a high degree of palatability so that pets can receive the full nutritional benefit from their food. Domestic animals, especially cats, are notoriously fickle in their food preferences, and often refuse to eat a pet food product that it has accepted over time or refuse to eat any more than a minimal amount of a pet food product. This phenomenon may be, in part, due to the subtle differences in the sensory profiles of the raw material, which can be perceived by the domestic animals because of their gustatory and olfactory systems. As a result, pet owners frequently change types and brands of pet food in order to maintain their pets in a healthy and contented condition.

While there have been recent advances in taste and flavor technologies, there remains a need for compounds that can enhance or modify the palatability of pet food products by enhancing or modifying the taste, texture and/or flavor profiles of the pet food product. The enhancement or modification can be to increase the intensity of a desirable attribute, to replace a desirable attribute not present or somehow lost in the pet food product, or to decrease the intensity of an undesirable attribute. In particular, it is desirable to increase the intensity of a desirable tastant in a pet food product. Therefore, there remains a need in the art for compositions to enhance the palatability and/or modulate the kokumi taste of pet food products.

### SUMMARY OF THE DISCLOSED SUBJECT MATTER

The presently disclosed subject matter is directed to flavor compositions and methods for making and modifying such compositions across a variety of pet food products. Specifically, the present disclosure is directed to compositions comprising one or more peptides that enhance, increase, decrease and/or modulate the activity of a calcium-sensing receptor (CaSR), and thereby modulate kokumi taste.

In certain embodiments, the flavor composition comprises an oligopeptide. In certain embodiments, the oligopeptide comprises a tripeptide motif. In certain embodiments, the tripeptide motif comprises:

(a) a first amino acid residue at the N-terminus that is a negatively charged amino acid residue or a polar, uncharged amino acid residue;

(b) a second amino acid residue that has a molecular mass of no more than 150 Dalton; and

(c) a third amino acid residue at the C-terminus that is a negatively charged amino acid residue or a polar, uncharged amino acid residue,

wherein the tripeptide binds to a calcium-sensing receptor (CaSR) to impart a kokumi taste to a companion animal.

In certain embodiments, the first amino acid residue is a negatively charged amino acid residue. In certain embodiments, the third amino acid residue is a negatively charged amino acid residue. In certain embodiments, the negatively charged amino acid residue is selected from the group consisting of aspartic acid (Asp), glutamic acid (Glu), and any phosphorylated amino acid residues. In certain embodiments, the negatively charged amino acid residue is a phosphorylated serine (pSer), a phosphorylated tyrosine (pTyr) or a phosphorylated threonine (pThr).

In certain embodiments, the first amino acid residue is a polar, uncharged amino acid residue. In certain embodiments, the third amino acid residue is a polar, uncharged amino acid residue. In certain embodiments, the polar, uncharged amino acid residue is selected from the group consisting of cycteine (Cys), glycine (Gly), glutamine (Gln), asparagine (Asp), serine (Ser), tyrosine (Tyr) and threonine (Thr).

In certain embodiments, the second amino acid residue is selected from the group consisting of lysine (Lys), isoleucine (Ile), a leucine (Leu), alanine (Ala), methionine (Met), proline (Pro), valine (Val), aspartic acid (Asp), glutamic acid (Glu), cycteine (Cys), glycine (Gly), glutamine (Gln), asparagine (Asn), serine (Ser) and threonine (Thr). In certain embodiments, the second amino acid residue is an alanine (Ala), a valine (Val) or a glutamic acid (Glu).

In certain embodiments, the oligopeptide is a tripeptide is selected from the group consisting of Asp-Val-Glu, Glu-Val-Asp, Asp-Glu-Glu, pSer-Glu-pSer, pSer-Val-pSer, pSer-Val-Glu, Ser-Glu-Ser, Cys-Val-Cys, pTyr-Glu-pTyr, pThr-Glu-pThr, Asp-Ala-Glu, Glu-Val-Glu, Asp-Val-Asp and any combination thereof.

In certain embodiments, the oligopeptide is selected from the group consisting of Ile-Gly-pSer-Glu-pSer-Thr-Glu-Asp-Gln (SEQ ID NO: 7), Ile-Gly-pSer-Glu-pSer-Thr-Glu-Asp-Gln-Ala (SEQ ID NO: 8), Glu-Ile-Val-Pro-Asn-pSer-Ala-Glu-Glu (SEQ ID NO: 9), Asp-Ile-Gly-pSer-Glu-pSer-Thr-Glu-Asp-Gln-Ala (SEQ ID NO: 10) and any combination thereof.

In certain embodiments, the companion animal is a cat or a dog. In certain embodiments, the companion animal is a cat.

In certain embodiments, the oligopeptide is generated during a manufacture process of a food product.

The presently disclosed subject matter provides food products comprising any flavor composition disclosed herein, wherein the flavor composition is present in an amount effective to increase a kokumi taste of the food product, as determined by a panel of taste testers. The presently disclosed subject matter provides food products comprising any flavor composition disclosed herein, wherein the flavor composition is present in an amount effective to increase the palatability of the food product, as determined by a panel of taste testers. In certain embodiments, the flavor composition is present at a concentration of from about 1 nM to about 1 M, from about 1 μM to about 1 M, from about 0.0001% to about 10% w/w, from about 0.001% to about 5% w/w, or from about 0.01% to about 1% w/w in the food product. In certain embodiments, the food product comprises a pet food product. In certain embodiments, the pet food product is a feline pet food product or a canine pet food product. In certain embodiments, the pet food product is a wet pet food product. In certain embodiments, the pet food product is a dry pet food product.

The presently disclosed subject matter provides methods for increasing a kokumi taste intensity in a food product comprising admixing a food product with any flavor composition disclosed herein, wherein the flavor composition is present in an amount effective to increase a kokumi taste of the food product, as determined by a panel of taste testers. In certain embodiments, the flavor composition is present at a concentration of from about 1 nM to about 1 M, from about 1 μM to about 1 M, from about 0.0001% to about 10% w/w, from about 0.001% to about 5% w/w, or from about 0.01% to about 1% w/w in the admixture.

In certain embodiments, the favor composition is generated during a manufacture process of a food product.

The presently disclosed subject matter provides methods of modulating the activity of a calcium-sensing receptor (CaSR) comprising contacting a CaSR with any flavor composition disclosed herein.

The presently disclosed subject matter provides methods for identifying a composition that modulates the activity of a CaSR. In certain embodiments, the method comprises:

(a) contacting a test agent with a CaSR,

(b) detecting an in silico interaction between the test agent and one or more amino acid residues selected from the group consisting of Pro39, Arg66, Gly67, Arg69, Trp70, Gly146, Ser147, Gly148, Tyr167, Ala168, Ser171, Ile187, Tyr218, Ser271, Glu297, Ser301, Ile416, and any combination thereof in a Venus Flytrap (VFT) domain interacting site of the CaSR, and

(c) selecting as the composition, a test agent that interacts with one or more of the amino acids.

In certain embodiments, step (b) further comprises detecting an interaction between the test agent and one or more amino acids in a Venus Flytrap (VFT) domain interacting site of the CaSR selected from the group consisting of Asn64, Asn102, Thr145, Ser169, Ser170, Ser272, Ala298, Trp299, Ala300, Ser302, and any combination thereof.

In certain embodiments, the method further comprises determining the activity of the CaSR after step (a). In certain embodiments, step (c) further comprises selecting as the composition, a test agent that increases the activity of the CaSR. In certain embodiments, the CaSR is expressed by a cell, and wherein the test agent is contacted to the cell. In certain embodiments, the cell expresses a calcium-binding photoprotein.

The foregoing has outlined rather broadly the features and technical advantages of the present application in order that the detailed description that follows may be better understood. Additional features and advantages of the application will be described hereinafter which form the subject of the claims of the application. It should be appreciated by those skilled in the art that the conception and specific embodiment disclosed may be readily utilized as a basis for modifying or designing other structures for carrying out the same purposes of the present application. It should also be realized by those skilled in the art that such equivalent constructions do not depart from the spirit and scope of the application as set forth in the appended claims. The novel features which are believed to be characteristic of the application, both as to its organization and method of operation, together with further objects and advantages will be better understood from the following description.

### BRIEF DESCRIPTION OF THE DRAWINGS

FIGS. 1A-1D depict the results of animal feeding tests of selected hydrolysates mixed in different matrices (maize gravy, gelatine gel and autoclave gel\) at 3%. FIG. 1A shows the results obtained using Maize starch matrices. FIG. 1B shows the results given by gelatine gel matrices. FIG. 1C shows the results obtained in tests usings autoclave gel matrices. FIG. 1D shows the feeding intake with gelatine gel matrices with 20 mM IMP.

FIGS. 2A-2B depict dose-response curves for test agent on feline CaSR. FIG. 2A shows dose-response curves for positive controls CaCl₂ and γEVG on feline CaSR. Each run was done on a separate day, and each data point represents the mean of four repetitions in one assay. The mock response of the mock cells was from the same date as run 2. FIG. 2B shows dose-response curves of 14 kokumi peptides on feline CaSR. Two runs for each ligand were conducted, and each run was done on a separate day, and each data point represents the mean of four repetitions in one assay. The response of the mock cells was from the same date as run 2.

FIGS. 3A-3C depict various aspects of in silico modelling of a feline CaSR with Asp-Val-Glu, aspartic acid and/or γ-Glu-Val-Gly. FIG. 3A shows a ribbon diagram of the in silico modelling of a feline CaSR with Asp-Val-Glu. FIG. 3B illustrates a ball and stick diagram of the in silico modelling of a feline CaSR with Asp-Val-Glu. FIG. 3C depicts an in silico modelling of a feline CaSR with γ-Glu-Val-Gly.

FIG. 4 depicts the amino acid sequence and the nucleotide sequence of feline, canine and human calcium-sensing receptors.

### DETAILED DESCRIPTION

To date, there remains a need for a flavor modifier that can increase and/or enhance the palatability of various pet food products. The present application relates to flavor compositions that include at least one peptide that modulates the activity of a calcium-sensing receptor (CaSR). The flavor compositions can be used to increase the palatability and/or enhance or modify the taste of various pet food products such as a nutritionally-complete pet food, and can be added to pet food products in various delivery system formats. The flavor compositions can further include combinations of compounds.

### 1. Definitions

The terms used in this specification generally have their ordinary meanings in the art, within the context of this invention and in the specific context where each term is used. Certain terms are discussed below, or elsewhere in the specification, to provide additional guidance to the practitioner in describing the compositions and methods of the invention and how to make and use them.

As used herein, the use of the word “a” or “an” when used in conjunction with the term “comprising” in the claims and/or the specification may mean “one,” but it is also consistent with the meaning of “one or more,” “at least one,” and “one or more than one.” Still further, the terms “having,” “including,” “containing” and “comprising” are interchangeable and one of skill in the art is cognizant that these terms are open ended terms.

The term “about” or “approximately” means within an acceptable error range for the particular value as determined by one of ordinary skill in the art, which will depend in part on how the value is measured or determined, i.e., the limitations of the measurement system. For example, “about” can mean within 3 or more than 3 standard deviations, per the practice in the art. Alternatively, “about” can mean a range of up to 20%, preferably up to 10%, more preferably up to 5%, and more preferably still up to 1% of a given value. Alternatively, particularly with respect to biological systems or processes, the term can mean within an order of magnitude, preferably within 5-fold, and more preferably within 2-fold, of a value.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The present disclosure also contemplates other embodiments “comprising,” “consisting of”, and “consisting essentially of,” the embodiments or elements presented herein, whether explicitly set forth or not.

As used herein, “taste” refers to a sensation caused by activation or inhibition of receptor cells in a subject's taste buds. In certain embodiments, taste can be selected from the group consisting of sweet, sour, salt, bitter, kokumi and umami. In certain embodiments, a taste is elicited in a subject by a “tastant.” In certain embodiments, a tastant is a synthetic tastant. In certain embodiments, the tastant is prepared from a natural source.

In certain embodiments, “taste” can include kokumi taste. See, e.g., Ohsu et al., J. Biol. Chem., 285(2): 1016-1022 (2010), the contents of which are incorporated herein by reference. In certain embodiments, kokumi taste is a sensation caused by activation or inhibition of receptor cells in a subject's taste buds, for example the receptor CaSR, and is separate than other tastes, for example, sweet, salty, and umami tastes, although it can act as a taste enhancer for these tastes.

As used herein, “taste profile” refers to a combination of tastes, such as, for example, one or more of a sweet, sour, salt, bitter, umami, kokumi and free fatty acid taste. In certain embodiments, a taste profile is produced by one or more tastant that is present in a composition at the same or different concentrations. In certain embodiments, a taste profile refers to the intensity of a taste or combination of tastes, for example, a sweet, sour, salt, bitter, umami, kokumi and free fatty acid taste, as detected by a subject or any assay known in the art. In certain embodiments, modifying, changing or varying the combination of tastants in a taste profile can change the sensory experience of a subject.

As used herein, “taste tester” refers to any mammal, such as human, cat, or dog, that samples composition or food or drink products containing such compositions for its palatability. In certain embodiments, a taste tester provides a feedback on the palatability of the composition tested based on testing parameters and protocols. As used herein, “flavor” refers to one or more sensory stimuli, such as, for example, one or more of taste (gustatory), smell (olfactory), touch (tactile) and temperature (thermal) stimuli. In certain non-limiting embodiments, the sensory experience of a subject exposed to a flavor can be classified as a characteristic experience for the particular flavor. For example, a flavor can be identified by the subject as being, but not limited to, a floral, citrus, berry, nutty, caramel, chocolate, peppery, smoky, cheesy, meaty, etc., flavor. As used herein, a flavor composition can be selected from a liquid, solution, dry powder, spray, paste, suspension and any combination thereof. The flavor can be a natural composition, an artificial composition, a nature identical, or any combination thereof.

As used interchangeably herein, “aroma” and “smell” refer to an olfactory response to a stimulus. For example, and not by way of limitation, an aroma can be produced by aromatic substances that are perceived by the odor receptors of the olfactory system.

As used herein, “flavor profile” refers to a combination of sensory stimuli, for example, tastes, such as sweet, sour, bitter, salty, umami, kokumi and free fatty acid tastes, and/or olfactory, tactile and/or thermal stimuli. In certain embodiments, the flavor profile comprises one or more flavors which contribute to the sensory experience of a subject. In certain embodiments, modifying, changing or varying the combination of stimuli in a flavor profile can change the sensory experience of a subject.

As used herein “admixing,” for example, “admixing the flavor composition or combinations thereof of the present application with a food product,” refers to the process where the flavor composition, or individual components of the flavor composition, is mixed with or added to the completed product or mixed with some or all of the components of the product during product formation or some combination of these steps. When used in the context of admixing, the term “product” refers to the product or any of its components. This admixing step can include a process selected from the step of adding the flavor composition to the product, spraying the flavor composition on the product, coating the flavor composition on the product, suspending the product in the flavor composition, painting the flavor composition on the product, pasting the flavor composition on the product, encapsulating the product with the flavor composition, mixing the flavor composition with the product and any combination thereof. The flavor composition can be a liquid, emulsion, dry powder, spray, paste, suspension and any combination thereof.

In certain embodiments, the peptides/compounds of a flavor composition can be generated during the processing of a pet food product, e.g., sterilization, retorting and/or extrusion, from precursor compounds present in the pet food product. In certain embodiments, a peptide/compound of a flavor composition can be generated during the processing of a pet food product and additional components of the flavor composition can be added to the pet food product by admixing.

As used herein, “ppm” means parts-per-million and is a weight relative parameter. A part-per-million is a microgram per gram, such that a component that is present at 10 ppm is present at 10 micrograms of the specific component per 1 gram of the aggregate mixture.

As used herein, “palatability” can refer to the overall willingness of an animal to eat a certain food product. Increasing the “palatability” of a pet food product can lead to an increase in the enjoyment and acceptance of the pet food by the companion animal to ensure the animal eats a “healthy amount” of the pet food. The term “healthy amount” of a pet food as used herein refers to an amount that enables the companion animal to maintain or achieve an intake contributing to its overall general health in terms of micronutrients, macronutrients and calories, such as set out in the “Mars Petcare Essential Nutrient Standards.” In certain embodiments, “palatability” can mean a relative preference of an animal for one food product over another. For example, when an animal shows a preference for one of two or more food products, the preferred food product is more “palatable,” and has “enhanced palatability.” In certain embodiments, the relative palatability of one food product compared to one or more other food products can be determined, for example, in side-by-side, free-choice comparisons, e.g., by relative consumption of the food products, or other appropriate measures of preference indicative of palatability. Palatability can be determined by a standard testing protocol in which the animal has equal access to both food products such as a test called “two-bowl test” or “versus test.” Such preference can arise from any of the animal's senses, but can be related to, inter alia, taste, aftertaste, smell, mouth feel and/or texture.

The term “pet food” or “pet food product” means a product or composition that is intended for consumption by a companion animal, such as cats, dogs, guinea pigs, rabbits, birds and horses. For example, but not by way of limitation, the companion animal can be a “domestic” cat such as Felis catus. In certain embodiments, the companion animal can be a “domestic” dog, e.g., Canis lupus familiaris. A “pet food” or “pet food product” includes any food, feed, snack, food supplement, liquid, beverage, treat, toy (chewable and/or consumable toys), and meal substitute or meal replacement.

As used herein “nutritionally-complete” refers to pet food product that contains all known required nutrients for the intended recipient of the pet food product, in appropriate amounts and proportions based, for example, on recommendations of recognized or competent authorities in the field of companion animal nutrition. Such foods are therefore capable of serving as a sole source of dietary intake to maintain life, without the addition of supplemental nutritional sources.

As used herein “flavor composition” refers to at least one peptide/compound or biologically acceptable salt thereof that modulates, including enhancing, multiplying, potentiating, decreasing, suppressing, or inducing, the tastes, smells, flavors and/or textures of a natural or synthetic tastant, flavoring agent, taste profile, flavor profile and/or texture profile in an animal or a human. In certain embodiments, the flavor composition comprises a combination of compounds or biologically acceptable salts thereof. In certain embodiments, the flavor composition includes one or more excipients.

As used herein, the terms “modulates” or “modifies” refers an increase or decrease in the amount, quality or effect of a particular activity of a receptor and/or an increase or decrease in the expression, activity or function of a receptor. “Modulators,” as used herein, refer to any inhibitory or activating compounds identified using in silico, in vitro and/or in vivo assays for, e.g., agonists, antagonists and their homologs, including fragments, variants and mimetics.

“Inhibitors” or “antagonists,” as used herein, refer to modulating compounds that reduce, decrease, block, prevent, delay activation, inactivate, desensitize or downregulate biological activity and/or expression of receptors or pathway of interest.

“Inducers,” “activators” or “agonists,” as used herein, refer to modulating compounds that increase, induce, stimulate, open, activate, facilitate, enhance activation, sensitize or upregulate a receptor or pathway of interest.

In certain embodiments, an “active compound” is a compound/peptide that modulates, i.e., is active against, a calcium-sensitive receptor. For example, an active compound can be active against the calcium-sensitive receptor as an agonist, antagonist, positive allosteric modulator (PAM), negative allosteric modulator, or by showing a mix of activities, for example, as agonist activity as well as positive allosteric modulation activity, or agonist activity as well as negative allosteric modulation activity.

As used herein, the terms “vector” and “expression vector” refer to DNA molecules that are either linear or circular, into which another DNA sequence fragment of appropriate size can be integrated. Such DNA fragment(s) can include additional segments that provide for transcription of a gene encoded by the DNA sequence fragment. The additional segments can include and are not limited to: promoters, transcription terminators, enhancers, internal ribosome entry sites, untranslated regions, polyadenylation signals, selectable markers, origins of replication and such like. Expression vectors are often derived from plasmids, cosmids, viral vectors and yeast artificial chromosomes. Vectors are often recombinant molecules containing DNA sequences from several sources.

The term “nucleic acid molecule” and “nucleotide sequence,” as used herein, refers to a single or double stranded covalently-linked sequence of nucleotides in which the 3′ and 5′ ends on each nucleotide are joined by phosphodiester bonds. The nucleic acid molecule can include deoxyribonucleotide bases or ribonucleotide bases, and can be manufactured synthetically in vitro or isolated from natural sources.

The terms “polypeptide,” “peptide,” “amino acid sequence” and “protein,” used interchangeably herein, refer to a molecule formed from the linking of at least two amino acids. The link between one amino acid residue and the next is an amide bond and is sometimes referred to as a peptide bond. A polypeptide can be obtained by a suitable method known in the art, including isolation from natural sources, expression in a recombinant expression system, chemical synthesis or enzymatic synthesis. The terms can apply to amino acid polymers in which one or more amino acid residue is an artificial chemical mimetic of a corresponding naturally occurring amino acid, as well as to naturally occurring amino acid polymers and non-naturally occurring amino acid polymers.

The term “amino acid,” as used herein, refers to naturally occurring and synthetic amino acids, as well as amino acid analogs and amino acid mimetics that function in a manner similar to the naturally occurring amino acids. Naturally occurring amino acids are those encoded by the genetic code, as well as those amino acids that are later modified, e.g., hydroxyproline, gamma-carboxyglutamate and O-phosphoserine. Amino acid analogs and derivatives can refer to compounds that have the same basic chemical structure as a naturally occurring amino acid, i.e., a carbon that is bound to a hydrogen, a carboxyl group, an amino group and an R group, e.g., homoserine, norleucine, methionine sulfoxide and methionine methyl sulfonium. Such analogs can have modified R groups (e.g., norleucine) or modified peptide backbones, but retain the same basic chemical structure as a naturally occurring amino acid. Amino acid mimetics means chemical compounds that have a structure that is different from the general chemical structure of an amino acid, but that functions in a manner similar to a naturally occurring amino acid.

The terms “isolated” or “purified,” used interchangeably herein, refers to a nucleic acid, a polypeptide, or other biological moiety that is removed from components with which it is naturally associated. The term “isolated” can refer to a polypeptide that is separate and discrete from the whole organism with which the molecule is found in nature or is present in the substantial absence of other biological macromolecules of the same type. The term “isolated” with respect to a polynucleotide can refer to a nucleic acid molecule devoid, in whole or part, of sequences normally associated with it in nature; or a sequence, as it exists in nature, but having heterologous sequences in association therewith; or a molecule disassociated from the chromosome.

As used herein, the term “recombinant” can be used to describe a nucleic acid molecule and refers to a polynucleotide of genomic, RNA, DNA, cDNA, viral, semisynthetic or synthetic origin which, by virtue of its origin or manipulation is not associated with all or a portion of polynucleotide with which it is associated in nature.

The term “fusion,” as used herein, refers to joining of different peptide or protein segments by genetic or chemical methods wherein the joined ends of peptide or protein segments may be directly adjacent to each other or may be separated by linker or spacer moieties such as amino acid residues or other linking groups.

### 2. Calcium-Sensing Receptor (CaSR)

The presently disclosed subject matter provides calcium-sensing receptors for use in the disclosed methods. The calcium-sensing receptors of the present disclosure can include mammalian calcium-sensing receptors such as, but not limited to, feline, canine and human calcium-sensing receptors for the identification of kokumi-taste active compounds.

In certain non-limiting embodiments, the calcium-sensing receptor of the present disclosure is encoded by a nucleic acid as described by International Application No. PCT/US15/55149, filed Oct. 12, 2015, which is incorporated by reference in its entirety herein. In certain non-limiting embodiments, the calcium-sensing receptor of the present disclosure comprises an amino acid sequence as described by International Application No. PCT/US15/55149, filed Oct. 12, 2015.

In certain non-limiting embodiments, the calcium-sensing receptor comprises a feline, canine or human calcium-sensing receptor nucleotide sequence as described by International Application No. PCT/US15/55149, filed Oct. 12, 2015. In certain non-limiting embodiments, the calcium-sensing receptor of the present disclosure is encoded by a nucleic acid comprising a nucleotide sequence set forth in SEQ ID NO: 2, 4 or 6.

In certain non-limiting embodiments, the calcium-sensing receptor comprises a feline, canine or human calcium-sensing receptor amino acid sequence as described by International Application No. PCT/US15/55149, filed Oct. 12, 2015. In certain non-limiting embodiments, the calcium-sensing receptor of the present disclosure comprises an amino acid sequence set forth in SEQ ID NO: 1, 3 or 5.

In certain non-limiting embodiments, the calcium-sensing receptor is a feline calcium-sensing receptor comprising the amino acid sequence set forth in SEQ ID NO: 1. In certain non-limiting embodiments, the calcium-sensing receptor is a canine calcium-sensing receptor comprising the amino acid sequence set forth in SEQ ID NO: 3. In certain non-limiting embodiments, the calcium-sensing receptor is a human calcium-sensing receptor comprising the amino acid sequence set forth in SEQ ID NO: 5.

In certain embodiments, the calcium-sensing receptor for use in the presently disclosed subject matter can include a receptor comprising a nucleotide sequence having at least 85%, at least 90%, at least 91%, at least 92%, at least 93%, at least 94%, at least 95%, at least 96%, at least 97%, at least 98% or at least 99% identity to a feline, canine or human calcium-sensing receptor nucleotide sequence.

In certain embodiments, the calcium-sensing receptor for use in the presently disclosed subject matter can include a receptor comprising an amino acid sequence having at least 85%, at least 90%, at least 91%, at least 92%, at least 93%, at least 94%, at least 95%, at least 96%, at least 97%, at least 98% or at least 99% identity to a feline, canine or human calcium-sensing receptor amino acid sequence.

In certain embodiments, the disclosed subject matter provides for the use of an isolated or purified calcium-sensing receptor and/or variants and fragments thereof. The disclosed subject matter also encompasses the use of sequence variants. In certain embodiments, variation can occur in either or both the coding and non-coding regions of a nucleotide sequence of a calcium-sensing receptor. Variants can include a substantially homologous protein encoded by the same genetic locus in an organism, i.e., an allelic variant. Variants also encompass proteins derived from other genetic loci in an organism, e.g., feline, but having substantial homology to the calcium-sensing receptor, i.e., a homolog. Variants can also include proteins substantially homologous to the calcium-sensing receptor but derived from another organism, i.e., an ortholog. Variants also include proteins that are substantially homologous to the calcium-sensing receptor that are produced by chemical synthesis. Variants also include proteins that are substantially homologous to the calcium-sensing receptor that are produced by recombinant methods.

The disclosed subject matter also provides for fusion proteins that comprise a calcium-sensing receptor, or fragment thereof. In certain embodiments, a fusion protein of the present disclosure can include a detectable marker, a functional group such as a carrier, a label, a stabilizing sequence or a mechanism by which calcium-sensing receptor agonist binding can be detected. Non-limiting embodiments of a label include a FLAG tag, a His tag, a MYC tag, a maltose binding protein and others known in the art. The presently disclosed subject matter also provides nucleic acids encoding such fusion proteins, vectors containing fusion protein-encoding nucleic acids and host cells comprising such nucleic acids or vectors. In certain embodiments, fusions can be made at the amino terminus (N-terminus) of a calcium-sensing receptor or at the carboxy terminus (C-terminus) of a calcium-sensing receptor.

In certain embodiments, the calcium-sensing receptors disclosed herein can contain additional amino acids at the N-terminus and/or at the C-terminus end of the sequences, e.g., when used in the methods of the disclosed subject matter. In certain embodiments, the additional amino acids can assist with immobilizing the polypeptide for screening purposes, or allow the polypeptide to be part of a fusion protein, as disclosed above, for ease of detection of biological activity.

### 3. Calcium-Sensing Receptor Modulating Peptides

The present disclosure relates to flavor compositions comprising at least one compound that can modulate the activity of a calcium-sensing receptor (CaSR). The compounds disclosed herein were identified through an in vitro assay wherein the ability of the compounds to activate a feline CaSR expressed by cells in culture was determined, and/or an in silico assay, wherein the compounds' ability to bind to CaSR was determined in silico. The flavor compositions can be used to enhance or modify the palatability, taste or flavor of pet food products. In certain embodiments, the flavor compositions described herein can be added to pet food product compositions in various delivery system formats.

In certain embodiments, the CaSR modulating compound is a peptide, e.g., an oligopeptide. In certain embodiments, the peptide comprises a tripeptide motif according to the following formula:

[Negatively charged or polar amino acid]-[an amino acid that has a molecular mass of no more than 150 Dalton]-[Negatively charged or polar amino acid].

In certain embodiments, the tripeptide motif comprises:

(a) a first amino acid residue at the N-terminus that is a negatively charged amino acid residue or a polar, uncharged amino acid residue;

(b) a second amino acid residue that is a not too large amino acid; and

(c) a third amino acid residue at the C-terminus that is a negatively charged amino acid residue or a polar, uncharged amino acid residue. In certain embodiments, the tripeptide motif binds to a CaSR to impart a kokumi taste.

In certain embodiments, the first amino acid residue is a negatively charged amino acid residue. In certain embodiments, the third amino acid residue is a negatively charged amino acid residue. In certain embodiments, the negatively charged amino acid residue is selected from the group consisting of aspartic acid (Asp), β-aspartic acid (β-Asp), glutamic acid (Glu), γ-glutamic acid (γ-Glu) and any phosphorylated amino acid residues. In certain embodiments, the negatively charged amino acid residue is not a β-aspartic acid (β-Asp) or a γ-glutamic acid (γ-Glu). In certain embodiments, the first amino acid residue is not a β-aspartic acid (β-Asp) or a γ-glutamic acid (γ-Glu). In certain embodiments, the negatively charged amino acid residue is a phosphorylated serine (pSer), a phosphorylated tyrosine (pTyr) or a phosphorylated threonine (pThr).

In certain embodiments, the first amino acid residue is a polar, uncharged amino acid residue. In certain embodiments, the third amino acid residue is a polar, uncharged amino acid residue. In certain embodiments, the polar, uncharged amino acid residue is selected from the group consisting of cycteine (Cys), glycine (Gly), glutamine (Gln), asparagine (Asp), serine (Ser), tyrosine (Tyr) and threonine (Thr).

In certain embodiments, the second amino acid residue that has a molecular mass of no more than about 200 Dalton. In certain embodiments, the second amino acid residue that has a molecular mass of no more than about 150 Dalton, no more than about 140 Dalton, no more than about 130 Dalton, no more than about 120 Dalton, no more than about 110 Dalton, no more than about 100 Dalton, no more than about 90 Dalton, or no more than about 80 Dalton. In certain embodiments, the second amino acid residue that has a molecular mass of between about 50 Dalton and about 200 Dalton, between about 50 Dalton and about 150 Dalton, between about 60 Dalton and about 150 Dalton, between about 60 Dalton and about 140 Dalton, between about 60 Dalton and about 130 Dalton, or between about 60 Dalton and about 120 Dalton. In certain embodiments, the second amino acid residue is selected from the group consisting of lysine (Lys), isoleucine (Ile), leucine (Leu), alanine (Ala), methionine (Met), proline (Pro), valine (Val), aspartic acid (Asp), glutamic acid (Glu), cycteine (Cys), glycine (Gly), glutamine (Gln), asparagine (Asn), serine (Ser) and threonine (Thr). In certain embodiments, the second amino acid residue is an alanine (Ala), a valine (Val) or a glutamic acid (Glu).

In certain embodiments, the peptide is a tripeptide is selected from the group consisting of Asp-Val-Glu, Glu-Val-Asp, Asp-Glu-Glu, pSer-Glu-pSer, pSer-Val-pSer, pSer-Val-Glu, Ser-Glu-Ser, Cys-Val-Cys, pTyr-Glu-pTyr, pThr-Glu-pThr, Asp-Ala-Glu, Glu-Val-Glu, Asp-Val-Asp and any combination thereof.

In certain embodiments, the peptide is selected from the group consisting of Ile-Gly-pSer-Glu-pSer-Thr-Glu-Asp-Gln, Ile-Gly-pSer-Glu-pSer-Thr-Glu-Asp-Gln-Ala, Glu-Ile-Val-Pro-Asn-pSer-Ala-Glu-Glu, Asp-Ile-Gly-pSer-Glu-pSer-Thr-Glu-Asp-Gln-Ala and any combination thereof.

In certain embodiments, the peptide is capable of forming a Ca²⁺ chelator. In certain embodiments, the peptide is capable of activating a feline CaSR. In certain embodiments, the tripeptide motif of the peptide binds to the CaSR to impart a kokumi taste. In certain embodiments, the EC50 of the peptide for activating a CaSR is no more than about 100 mM, no more than about 90 mM, no more than about 80 mM, no more than about 70 mM, no more than about 60 mM, no more than about 50 mM, no more than about 40 mM, no more than about 30 mM, no more than about 20 mM, no more than about 10 mM, or no more than about 5 mM.

In certain embodiments, the peptides are comprised in a flavor composition without other palatability enhancing agents. In certain embodiments, the peptides are comprised in one or more flavor compositions with one or more additional palatability enhancing agents, for example, nucleotides, nucleotide derivatives, amino acids, furanones, fatty acid receptor activating compounds, and umami receptor activating compounds described herein.

In certain embodiments, the peptide can that interact with (e.g., bind to) the Venus Flytrap (VFT) domain of a CaSR. In certain embodiments, such interactions with the VFT domain of the CaSR agonizes the CaSR. In other embodiments, the peptide acts synergistically with other CaSR agonists or modulators to modulate the activity of the CaSR. In still other embodiments, interactions with the VFT domain of the CaSR antagonizes the CaSR. In certain embodiments, the peptide enhances the ability of a CaSR agonist to activate the receptor (i.e., the peptide functions as a positive allosteric modulator). In certain embodiments, the tripeptide motif of the peptide binds to the VFT domain of a CaSR to impart a kokumi taste.

In certain embodiments, the peptide interacts with one or more amino acids in the VFT domain, for example, one or more of Pro39, Asn64, Arg66, Gly67, Arg69, Trp70, Asn102, Thr145, Gly146, Ser147, Gly148, Tyr167, Ala168, Ser169, Ser170, Ser171, Ile187, Tyr218, Ser271, Ser272, Glu297, Ala298, Trp299, Ala300, Ser301, Ser302, and Ile416, and any combination thereof. Therefore, in certain embodiments, a calcium-sensing receptor modulating peptide can be identified and/or defined based on its interaction with one or more of these residues.

In certain embodiments, a CaSR agonist and/or modulator of the present disclosure comprise a salt of the CaSR agonist and/or modulator, for example, but not limited to, an acetate salt or a formate salt. In certain embodiments, the CaSR agonist and/or modulator salt comprises an anion (−) (for example, but not limited to, Cl⁻, O²⁻, CO₃²⁻, HCO₃⁻, OH⁻, NO₃⁻, PO₄³⁻, SO₄²⁻, CH₃COO⁻, HCOO⁻ and C₂O₄²⁻) bonded via an ionic bond with a cation (+) (for example, but not limited to, Al³⁺, Ca²⁺, Na⁺, K⁺, Cu²⁺, H⁺, Fe³⁺, Mg²⁺, NH₄⁺ and H₃O⁺). In other embodiments, the CaSR agonist salt comprises a cation (+) bonded via an ionic bond with an anion (−). In certain embodiments, the peptides of the present disclosure comprise a sodium salt or potassium salt of the peptide.

In certain embodiments, a CaSR agonist and/or peptide disclosed herein are comprised in a flavor composition in an amount of from about 0.001% to about 100% w/w, from about 0.1% to about 99.9% w/w, from about 1% to about 99% w/w, from about 1% to about 80% w/w, from about 1% to about 50% w/w, from about 1% to about 20% w/w, from about 50% to about 100% w/w, from about 20% to about 80% w/w, or from about 30% to about 70% w/w.

In certain embodiments, the CaSR agonist and/or modulator peptide is generated during a manufacture process of a food product, e.g., through hydrolysis of a raw material.

### 4. Methods for Identifying Calcium-Sensing Receptor Modulating Compounds

The present disclosure further provides methods for identifying compounds that modulate the activity and/or expression of a calcium-sensing receptor. For example, and not by way of limitation, the modulator can be an agonist or an antagonist. The presently disclosed subject matter provides in silico and in vitro methods for identifying those compounds that modulate the activity and/or expression of a calcium-sensing receptor, disclosed above.

### 4.1 In silico Methods

The presently disclosed subject matter further provides in silico methods for identifying compounds that can potentially interact with a calcium-sensing receptor and/or modulate the activity and/or expression of a calcium-sensing receptor, for example, a feline, canine or human calcium-sensing receptor.

In certain embodiments, the method can include predicting the three-dimensional structure (3D) of a calcium-sensing receptor and screening the predicted 3D structure with putative calcium-sensing receptor modulating compounds (i.e., test compounds/peptides). The method can further include predicting whether the putative compound would interact with the binding site of the receptor by analyzing the potential interactions with the putative compound and the amino acids of the receptor. The method can further include identifying a test compound that can bind to and/or modulate the biological activity of the calcium-sensing receptor by determining whether the 3D structure of the compound fits within the binding site of the 3D structure of the receptor.

In certain embodiments, the calcium-sensing receptor for use in the disclosed method can have an amino acid or nucleotide sequence as described by International Application No. PCT/US15/55149, filed Oct. 12, 2015, or a fragment or variant thereof.

Non-limiting examples of compounds (e.g., potential calcium-sensing receptor modulators) that can be tested using the disclosed methods include any small chemical compound, or any biological entity, such as peptides, salts, and amino acids known in the art. In certain embodiments, the test compound can be a small chemical molecule.

In certain embodiments, structural models of a calcium-sensing receptor can be built using crystal structures of closely related GPCRs as templates for homology modeling. X-ray crystalogaphic structures of the human calcium receptor Venus Flytrap Domain (VFT) have been solved recently. Structures available in the Protein Databank (PDB, www.rcsb.org) are:

PDB ID: 5FBH—crystal structure of the extracellular domain of human calcium sensing receptor with bound Gd⁺³;

PDB ID: 5FBK—crystal structure of the extracellular domain of human calcium sensing receptor;

PDB ID: 5K5T—crystal structure of the inactive form of human calcium-sensing receptor extracellular domain;

PDB ID: 5K5S—crystal structure of the active form of human calcium-sensing receptor extracellular domain (See Geng, et al., Structural mechanism of ligand activation in human calcium-sensing receptor, Elife. 2016 July 19; 5. pii: e13662; Zhang, et al., Structural basis for regulation of human calcium-sensing receptor by magnesium ions and an unexpected tryptophan derivative co-agonist, Sci Adv. 2016 May; 2(5): e1600241, the disclosures of which are hereby incorporated by reference in their entireties).

In certain embodiments, model VFT structures can be generated for other species of interest such as cat and dog based on sequence homology to the human VFT.

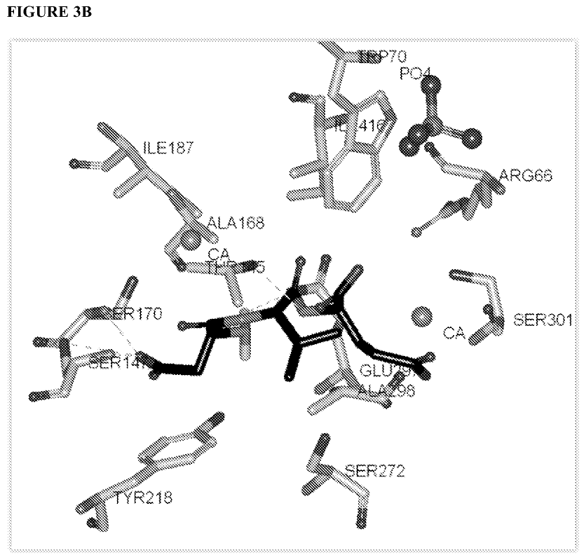

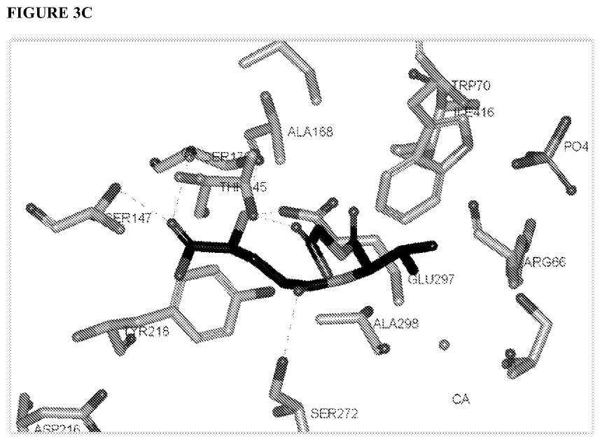

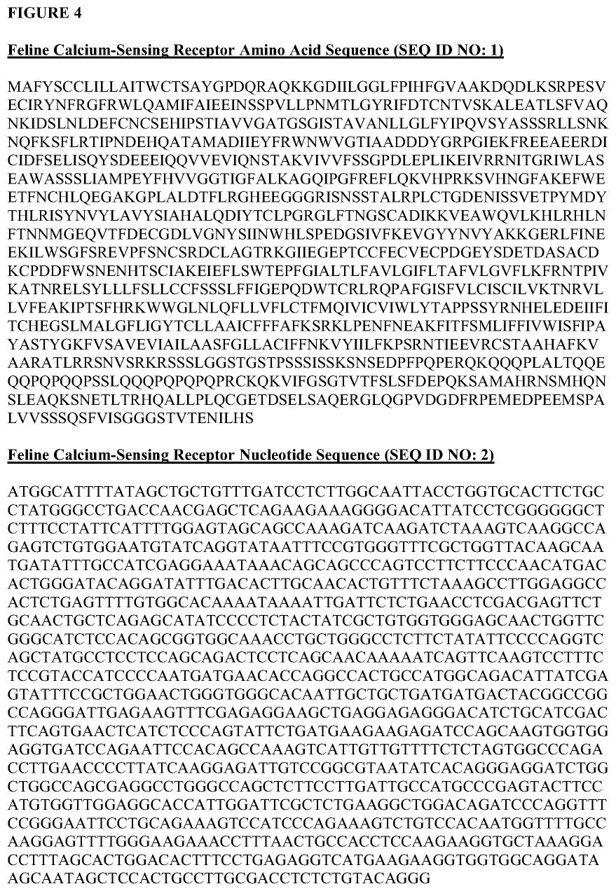

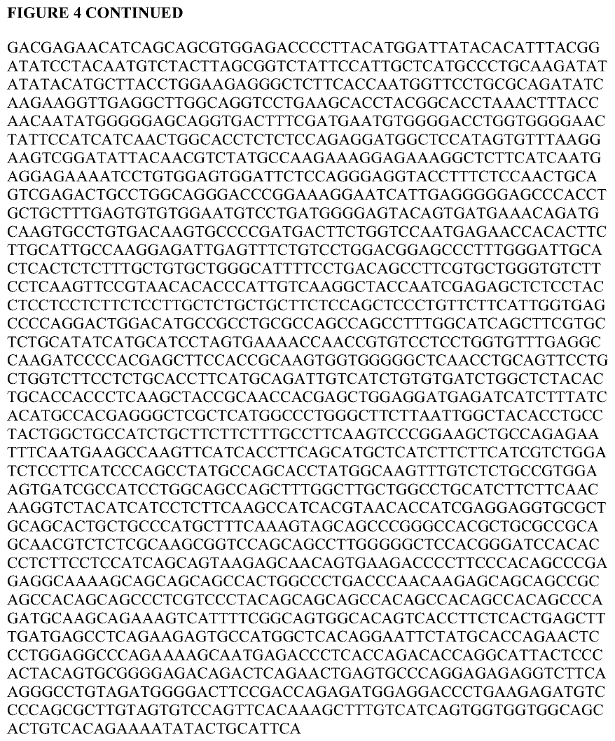

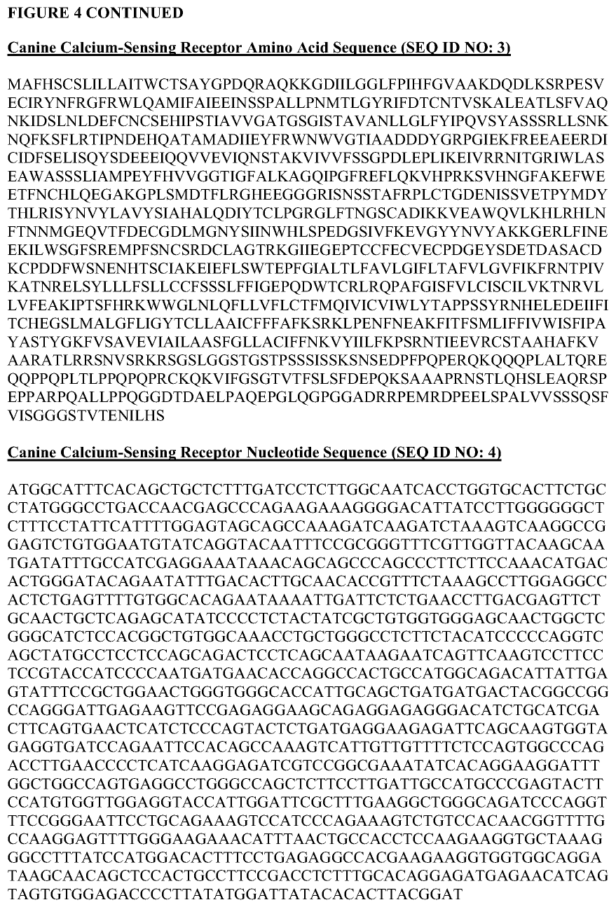

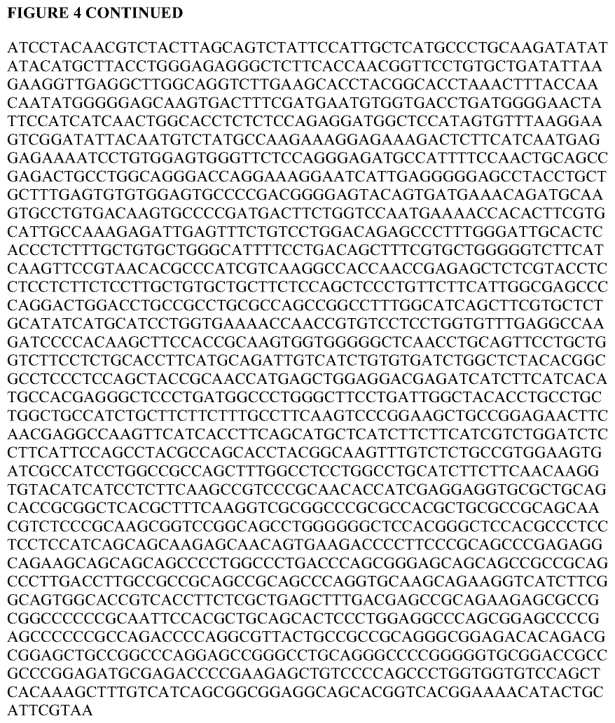

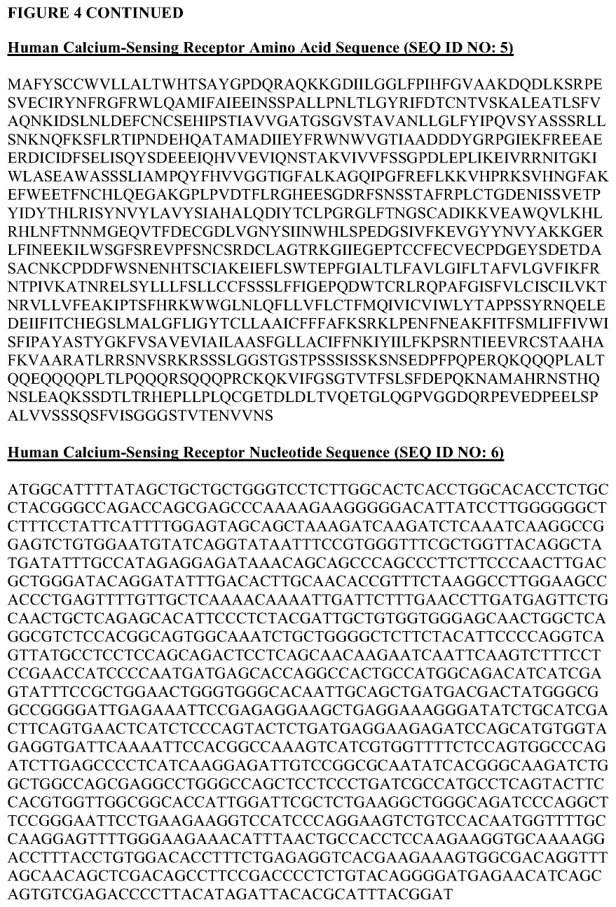

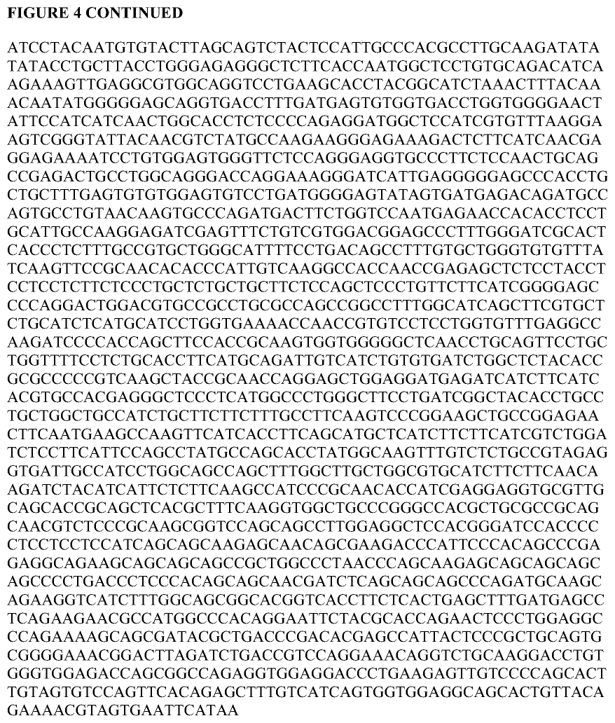

FIGS. 3A-3C depict structural models of calcium-sensing receptors that can be used in the disclosed in silico methods. Any suitable modeling software known in the art can be used. In certain embodiments, the Modeller software package (Accelrys, BIOVIA, Dassault Systèmes) can be used to generate the three-dimensional protein structure.

In certain embodiments, the in silico methods of identifying a compound that binds to a calcium-sensing receptor comprises determining whether a test compound interacts with one or more amino acids of a calcium-sensing receptor interacting domain, as described herein.

Compounds that are identified by the disclosed in silico methods can be further tested using the in vitro methods disclosed herein.

### 4.2 Calcium-Sensing Receptor Binding Site

The present application provides for methods of screening for compounds that modulate the activity of a calcium-sensing receptor, for example, a feline, canine or human calcium-sensing receptor, wherein the compounds interact with one or more amino acids of the calcium-sensing receptor. In certain embodiments, the binding site of a calcium-sensing receptor comprises amino acids within the Venus Flytrap (VFT) domain of the receptor, and can be identified by generating an interaction map of the receptor using in silico modeling, as described herein. In one non-limiting example, the presence of an amino acid in the interaction map means that the residue is in the vicinity of the ligand binding environment and interacts with the ligand.

In certain embodiments, the interaction between a compound and one or more amino acids of the calcium-sensing receptors described herein can comprise one or more hydrogen bond, covalent bond, non-covalent bond, salt bridge, physical interaction, and combinations thereof. The interactions can also be any interaction characteristic of a ligand receptor interaction known in the art. Such interactions can be determined by, for example, site directed mutagenesis, x-ray crystallography, x-ray or other spectroscopic methods, Nuclear Magnetic Resonance (NMR), cross-linking assessment, mass spectroscopy or electrophoresis, cryo-microscopy, displacement assays based on known agonists, structural determination and combinations thereof. In certain embodiments, the interactions are determined in silico, for example, by theoretical means such as docking a compound into a feline or canine calcium-sensing receptor binding pocket as described herein, for example, using molecular docking, molecular modeling, molecular simulation, or other means known to persons of ordinary skill in the art.

In certain embodiments, the interaction is a salt bridge interaction.

In certain embodiments, the interaction is a hydrogen bond interaction.

In certain embodiments, the interaction is a hydrophobic interaction.

In certain embodiments, the interaction is a ring stacking interaction.

In certain embodiments, the compounds identified according to the methods described herein that modulate the activity of a calcium-sensing receptor interact with one or more amino acids in the Venus Flytrap (VFT) domain of the calcium-sensing receptor. In certain embodiments, the amino acids that the compounds interact with comprise 1, 2, 3, 4, 5, 6, 7, 8, 9, 10, 11, 12, 13, 14, 15, 16, 17, 18, 19, 20, 21 22 or more of Pro39, Asn64, Arg66, Gly67, Arg69, Trp70, Asn102, Thr145, Gly146, Ser147, Gly148, Tyr167, Ala168, Ser169, Ser170, Ser171, Ile187, Tyr218, Ser271, Ser272, Glu297, Ala298, Trp299, Ala300, Ser301, Ser302, and Ile416 and any combination thereof in a calcium-sensing receptor, for example, a calcium-sensing receptor comprising a feline calcium-sensing receptor, or the functionally equivalent amino acids of a canine calcium-sensing receptor or a human calcium-sensing receptor.

In certain embodiments, the methods for identifying a composition that modulates the activity of a feline calcium-sensing receptor comprises (a) contacting a test agent with a calcium-sensing receptor, for example, a feline calcium-sensing receptor comprising an amino acid sequence of SEQ ID NO: 1, (b) detecting an interaction between the test agent and one or more amino acids in an interacting site of the calcium-sensing receptor selected from the group consisting of Pro39, Asn64, Arg66, Gly67, Arg69, Trp70, Asn102, Thr145, Gly146, Ser147, Gly148, Tyr167, Ala168, Ser169, Ser170, Ser171, Ile187, Tyr218, Ser271, Ser272, Glu297, Ala298, Trp299, Ala300, Ser301, Ser302, and Ile416, and any combinations thereof in the VFT domain, and (c) selecting as the composition, a test agent that interacts with one or more of the amino acids.

In certain embodiments, the method further comprises determining the activity of the calcium-sensing receptor after step (a), and selecting as the composition, a test agent that increases the activity of the calcium-sensing receptor.

In certain embodiments, the method further comprises contacting the calcium-sensing receptor with a ligand, for example an agonist, and selecting as the composition, a test agent that increases or enhances the agonist's ability to activate the calcium-sensing receptor.

### 4.3 In Vitro Methods

The presently disclosed subject matter further provides in vitro methods for identifying compounds that can modulate the activity and/or expression of a calcium-sensing receptor.

The calcium-sensing receptors for use in the presently disclosed methods can include isolated or recombinant calcium-sensing receptors or cells expressing a calcium-sensing receptor, disclosed herein. In certain embodiments, the calcium-sensing receptor for use in the disclosed methods can have an amino acid or nucleotide sequence as described by International Application No. PCT/US15/55149, filed Oct. 12, 2015, or a fragment or variant thereof.

In certain embodiments, the method for identifying compounds that modulate the activity and/or expression of a calcium-sensing receptor comprises measuring the biological activity of a calcium-sensing receptor in the absence and/or presence of a test compound. In certain embodiments, the method can include measuring the biological activity of a calcium-sensing receptor in the presence of varying concentrations of the test compound. The method can further include identifying the test compounds that result in a modulation of the activity and/or expression of the calcium-sensing receptor compared to the activity and/or expression of the calcium-sensing receptor in the absence of the test compound.

In certain embodiments, the compounds identified according to the methods described herein increase the biological activity of a calcium-sensing receptor by at least about 5%, about 10%, about 15%, about 20%, about 25%, about 30%, about 35%, about 40%, about 45%, about 50%, about 55%, about 60%, about 65%, about 70%, about 75%, about 80%, about 85%, about 90%, about 95%, about 100%, or more, compared to the biological activity of the calcium-sensing receptor when the compound is not present. In certain embodiments, the compounds identified according to the methods described herein increase the biological activity of a calcium-sensing receptor by at least about 30% compared to the biological activity of the calcium-sensing receptor when the compound is not present.

In certain embodiments, the method can further include analyzing two or more, three or more or four or more test compounds in combination. In certain embodiments, the two or more, three or more or four or more test compounds can be from different classes of compounds, e.g., amino acids and small chemical compounds. For example, and not by way of limitation, the method can include analyzing the effect of one or more small chemical test compounds on the biological activity and/or expression of a calcium-sensing receptor in the presence of one or more amino acid test compounds. In certain embodiments, the method for identifying a compound's effect on the activity and/or expression of a calcium-sensing receptor comprises analyzing the effect of a test compound on the biological activity and/or expression of a calcium-sensing receptor in the presence of one or more nucleotide or nucleotide derivative test compounds.

In certain embodiments, the method for identifying compounds that modulate the activity and/or expression of a calcium-sensing receptor comprises determining whether a compound modulates the receptor directly, for example, as an agonist or antagonist. In certain embodiments, the method comprises determining whether a compound indirectly modulates the activity of the receptor (e.g., as an allosteric modulator), for example, by enhancing or decreasing the effect of other compounds on activating or inhibiting receptor activity.

In certain embodiments, the method for identifying compounds that modulate the activity and/or expression of a calcium-sensing receptor comprises expressing a calcium-sensing receptor in a cell line and measuring the biological activity of the receptor in the presence and/or absence of a test compound. The method can further comprise identifying test compounds that modulate the activity of the receptor by determining if there is a difference in receptor activation in the presence of a test compound compared to the activity of the receptor in the absence of the test compound. In certain embodiments, the selectivity of the putative calcium-sensing receptor agonist and/or modulator can be evaluated by comparing its effects on other GPCRs or taste receptors, e.g., umami, GPR120, T1R, etc. receptors.

Activation of the receptor in the disclosed methods can be detected through the use of a labeling compound and/or agent. In certain embodiments, the activity of the calcium-sensing receptor can be determined by the detection of secondary messengers such as, but not limited to, cAMP, cGMP, IP3, DAG or calcium. In certain embodiments, the activity of the calcium-sensing receptor can be determined by the detection of the intracellular calcium levels. Monitoring can be by way of luminescence or fluorescence detection, such as by a calcium sensitive fluorescent dye. In certain embodiments, the intracellular calcium levels can be determined using a cellular dye, e.g., a fluorescent calcium indicator such as Calcium 4. In certain embodiments, the intracellular calcium levels can be determined by measuring the level of calcium binding to a calcium-binding protein, for example, calmodulin. Alternatively and/or additionally, activity of the calcium-sensing receptor can be determined by detection of the phosphorylation, transcript levels and/or protein levels of one or more downstream protein targets of the calcium-sensing receptor.

The cell line used in the disclosed methods can include any cell type that is capable of expressing a calcium-sensing receptor. Non-limiting examples of cells that can be used in the disclosed methods include HeLa cells, Chinese hamster ovary cells (CHO cells), African green monkey kidney cells (COS cells), Xenopus oocytes, HEK-293 cells and murine 3T3 fibroblasts. In certain embodiments, the method can include expressing a calcium-sensing receptor in CHO-K1 cells. In certain embodiments, the method can include expressing a calcium-sensing receptor in HEK-293 cells. In certain embodiments, the method can include expressing a calcium-sensing receptor in COS cells. In certain embodiments, the cells constitutively express the calcium-sensing receptor. In another embodiment, expression of the calcium-sensing receptor by the cells is inducible.

In certain embodiments, the cell expresses a calcium-binding photoprotein, wherein the photoprotein luminesces upon binding calcium. In certain embodiments, the calcium binding photoprotein comprises the protein clytin. In certain embodiments the clytin is a recombinant clytin. In certain embodiments, the clytin comprises an isolated clytin, for example, a clytin isolated from Clytia gregarium. In certain embodiments, the calcium-binding photoprotein comprises the protein aequorin, for example, a recombinant aequorin or an isolated aequorin, such as an aequorin isolated from Aequorea victoria. In certain embodiments, the calcium-binding photoprotein comprises the protein obelin, for example, a recombinant obelin or an isolated obelin, such as an obelin isolated from Obelia longissima.

In certain embodiments, expression of a calcium-sensing receptor in a cell can be performed by introducing a nucleic acid encoding a calcium-sensing receptor into the cell. For example, and not by way of limitation, a nucleic acid having the nucleotide sequence set forth in International Application No. PCT/US15/55149, filed Oct. 12, 2015, or a fragment thereof, can be introduced into a cell. In certain embodiments, the introduction of a nucleic acid into a cell can be carried out by any method known in the art, including but not limited to transfection, electroporation, microinjection, infection with a viral or bacteriophage vector containing the nucleic acid sequences, cell fusion, chromosome-mediated gene transfer, microcell-mediated gene transfer, spheroplast fusion, etc. Numerous techniques are known in the art for the introduction of foreign genes into cells (see, e.g., Loeffler and Behr, Meth. Enzymol. 217:599-618 (1993); Cohen et al., Meth. Enzymol. 217:618-644 (1993); Cline, Pharmac. Ther. 29:69-92 (1985), the disclosures of which are hereby incorporated by reference in their entireties) and can be used in accordance with the disclosed subject matter. In certain embodiments, the technique can provide for stable transfer of nucleic acid to the cell, so that the nucleic acid is expressible by the cell and inheritable and expressible by its progeny. In certain embodiments, the technique can provide for a transient transfer of the nucleic acid to the cell, so that the nucleic acid is expressible by the cell, wherein heritability and expressibility decrease in subsequent generations of the cell's progeny.

In certain embodiments, the method can include identifying compounds that bind to a calcium-sensing receptor. The method can comprise contacting a calcium-sensing receptor with a test compound and measuring binding between the compound and the calcium-sensing receptor. For example, and not by way of limitation, the methods can include providing an isolated or purified calcium-sensing receptor in a cell-free system, and contacting the receptor with a test compound in the cell-free system to determine if the test compound binds to the calcium-sensing receptor. In certain embodiments, the method can comprise contacting a calcium-sensing receptor expressed on the surface of a cell with a test compound and detecting binding of the test compound to the calcium-sensing receptor. The binding can be measured directly, e.g., by using a labeled test compound, or can be measured indirectly. In certain embodiments, the detection comprises detecting a physiological event in the cell caused by the binding of the compound to the calcium-sensing receptor, e.g., an increase in the intracellular calcium levels. For example, and not by way of limitation, detection can be performed by way of fluorescence detection, such as a calcium sensitive fluorescent dye, by detection of luminescence, or any other method of detection known in the art.

In certain non-limiting embodiments, the in vitro assay comprises cells expressing a calcium-sensing receptor that is native to the cells. Examples of such cells expressing a native calcium-sensing receptor include, for example but not limited to, dog (canine) and/or cat (feline) taste cells (e.g., primary taste receptor cells). In certain embodiments, the dog and/or cat taste cells expressing a calcium-sensing receptor are isolated from a dog and/or cat and cultured in vitro. In certain embodiments, the taste receptor cells can be immortalized, for example, such that the cells isolated from a dog and/or cat can be propagated in culture.

In certain embodiments, expression of a calcium-sensing receptor in a cell can be induced through gene editing, for example, through use of the CRISPR gene editing system to incorporate a calcium-sensing receptor gene into the genome of a cell, or to edit or modify a calcium-sensing receptor gene native to the cell.

In certain embodiments, the in vitro methods of identifying a compound that binds to a calcium-sensing receptor comprises determining whether a test compound interacts with one or more amino acids of a calcium-sensing receptor interacting domain, as described herein.

In certain embodiments, compounds identified as agonists and/or modulators of a calcium-sensing receptor can be further tested in other analytical methods including, but not limited to, in vivo assays, to confirm or quantitate their modulating activity.

In certain embodiments, methods described herein can comprise determining whether the calcium-sensing receptor modulator is a calcium-sensing taste enhancing compound, e.g., a calcium-sensing receptor agonist.

In certain embodiments, the methods of identifying a calcium-sensing receptor agonist and/or modulator can comprise comparing the effect of a test compound to a calcium-sensing receptor agonist. For example, a test compound that increases the activity of the receptor compared to the activity of the receptor when contacted with a calcium-sensing receptor agonist can be selected as a calcium-sensing receptor modulating compound (e.g., as an agonist).

In certain embodiments, the methods of identifying a calcium-sensing receptor modulator can comprise determining whether a test compound modulates the activity of the receptor when the receptor is contacted with an agonist, or whether the test compound can modulate the activity of a positive allosteric modulator (PAM). Test compounds that increase or decrease the effect of said agonist or PAM on the receptor can be selected as a calcium-sensing receptor modulating compound (e.g., as an allosteric modulator).

### 5. Flavor Compositions

In certain embodiments, the flavor compositions of the present disclosure can be used to increase the palatability of pet food products, such as cat food products. The flavor compositions can include combinations of compounds, and can be added to the pet food product in various delivery systems.

In certain embodiments, the present disclosure relates to methods for modulating the kokumi taste (for example, the activity of a calcium-sensing receptor) and/or the palatability of a pet food product comprising: a) providing at least one pet food product, or a precursor thereof, and b) combining the pet food product, or precursor thereof, with at least a kokumi taste modulating amount of at least one flavor composition, for example, comprising one or more active compounds, or a comestibly acceptable salt thereof, so as to form an enhanced pet food product.

In certain embodiments, the flavor compositions of the present disclosure can enhance the activity of a calcium-sensing receptor and/or palatability of a pet food product, such as, for example, a pet food product including wet pet food products, dry pet food products, moist pet food products, pet beverage products and/or snack pet food products.

In certain embodiments, one or more of the flavor compositions of the present disclosure can be added to a pet food product, in an amount effective to modify, enhance or otherwise alter a taste or taste profile of the pet food product. The modification can include, for example, an increase or enhancement in the palatability of the pet food product, as determined by animals, e.g., cats and/or dogs, or in the case of formulation testing, as determined by a panel of animal taste testers, e.g., cats and/or dogs, via procedures known in the art. In certain embodiments, the CaSR agonist and/or modulator peptide of the favor composition is generated during a manufacture process of a food product, e.g., through hydrolysis of a raw material.

In certain embodiments of the present disclosure, a pet food product can be produced that contains a sufficient amount of at least one flavor composition described herein, for example, comprising a peptide, to produce a pet food product having the desired taste, e.g., kokumi taste.

In certain embodiments of the present disclosure, a pet food product can be produced that contains a sufficient amount of a flavor composition comprising at least one, two, three, four, five, six or more peptides.

In certain embodiments, a calcium-sensing receptor modulating amount of one or more of the flavor compositions of the present disclosure can be added to the pet food product, so that the pet food product has an increased palatability as compared to a pet food product prepared without the flavor composition, as determined by animals, e.g., cats and/or dogs, or in the case of formulation testing, as determined by a panel of animal taste testers, via procedures known in the art.

In certain embodiments of the present disclosure, the flavor composition is added to a pet food product in an amount effective to increase, enhance and/or modify the palatability of the pet food product.

The concentration of flavor composition admixed with a pet food product to modulate and/or improve the palatability of the pet food product can vary depending on variables, such as, for example, the specific type of pet food product, what taste modulating compounds/peptides are already present in the pet food product and the concentrations thereof, and the enhancer effect of the particular flavor composition on such taste modulating compounds/peptides.

A broad range of concentrations of the flavor compositions can be employed to provide such palatability modification. In certain embodiments of the present application, the flavor composition is admixed with a pet food product wherein the flavor composition is present in an amount of from about 0.001 ppm to about 1,000 ppm. For example, but not by way of limitation, the flavor composition can be present in the amount from about 0.001 ppm to about 750 ppm, from about 0.001 ppm to about 500 ppm, from about 0.001 ppm to about 250 ppm, from about 0.001 ppm to about 150 ppm, from about 0.001 ppm to about 100 ppm, from about 0.001 ppm to about 75 ppm, from about 0.001 ppm to about 50 ppm, from about 0.001 ppm to about 25 ppm, from about 0.001 ppm to about 15 ppm, from about 0.001 ppm to about 10 ppm, from about 0.001 ppm to about 5 ppm, from about 0.001 ppm to about 4 ppm, from about 0.001 ppm to about 3 ppm, from about 0.001 ppm to about 2 ppm, from about 0.001 ppm to about 1 ppm, from about 0.01 ppm to about 1,000 ppm, from about 0.1 ppm to 1,000 ppm, from about 1 ppm to 1,000 ppm, from about 2 ppm to about 1,000 ppm, from about 3 ppm to about 1,000 ppm, from about 4 ppm to about 1,000 ppm, from about 5 ppm to about 1,000 ppm, from about 10 ppm to about 1,000 ppm, from about 15 ppm to about 1,000 ppm, from about 25 ppm to about 1,000 ppm, from about 50 ppm to about 1,000 ppm, from about 75 ppm to about 1,000 ppm, from about 100 ppm to about 1,000 ppm, from about 150 ppm to about 1,000 ppm, from about 250 ppm to about 1,000 ppm, from about 250 ppm to about 1,000 ppm, from about 500 ppm to about 1,000 ppm or from about 750 ppm to about 1,000 ppm, and values in between.

In certain embodiments of the present application, the flavor composition is admixed with a pet food product wherein the flavor composition is present in an amount of from about 0.001 ppm to about 500 ppm, or from about 0.01 ppm to about 500 ppm, from about 0.1 ppm to about 500 ppm, or from about 1 ppm to about 500 ppm, and values in between.

In certain embodiments of the present application, the flavor composition is admixed with a pet food product wherein the flavor composition is present in an amount of from about 0.01 ppm to about 100 ppm, or from about 0.1 ppm to about 100 ppm, or from about 1 ppm to about 100 ppm, and values in between.

In certain embodiments, the flavor composition is present in the pet food product at an amount greater than about 0.001 ppm, greater than about 0.01 ppm, greater than about 0.1 ppm, greater than about 1 ppm, greater than about 2 ppm, greater than about 3 ppm, greater than about 4 ppm, greater than about 5 ppm, greater than about 10 ppm, greater than about 25 ppm, greater than about 50 ppm, greater than about 75 ppm, greater than about 100 ppm, greater than about 250 ppm, greater than about 500 ppm, greater than about 750 ppm or greater than about 1000 ppm, and values in between.

In certain embodiments, a peptide of the present disclosure is present in a food product in an amount that is sufficient to modulate, activate and/or enhance a calcium-sensing receptor. For example, but not by way of limitation, a peptide can be present in a food product in an amount from about 1 nM to about 1 M, from about 1 μM to about 1 M, from about 1 mM to about 1 M, from about 10 mM to about 1 M, from about 100 mM to about 1 M, from about 250 mM to about 1 M, from about 500 mM to about 1 M, from about 750 mM to about 1 M, from about 0.001 μM to about 1 M, from about 0.001 μM to about 750 mM, from about 0.001 μM to about 500 mM, from about 0.001 μM to about 250 mM, from about 0.001 μM to about 100 mM, from about 0.001 μM to about 50 mM, from about 0.001 μM to about 25 mM, from about 0.001 μM to about 10 mM, from about 0.001 μM to about 1 mM, from about 0.001 μM to about 100 μM or from about 0.001 μM to about 10 μM, and values in between.

In certain embodiments, a peptide of the present disclosure is present in a food product in an amount that is sufficient to modulate, activate and/or enhance a calcium-sensing receptor. For example, but not by way of limitation, a peptide can be present in a food product in an amount from about 1 nM to about 10 M, from about 1 nM to about 1 M, from about 1 μM to about 1 M, from about 1 mM to about 1 M, from about 10 mM to about 1 M, from about 100 mM to about 1 M, from about 250 mM to about 1 M, from about 500 mM to about 1 M, from about 750 mM to about 1 M, from about 1 μM to about 1 M, from about 1 μM to about 750 mM, from about 1 μM to about 500 mM, from about 1 μM to about 250 mM, from about 1 μM to about 100 mM, from about 1 μM to about 50 mM, from about 1 μM to about 25 mM, from about 1 μM to about 10 mM, from about 1 μM to about 1 mM, from about 1 μM to about 100 μM or from about 1 μM to about 10 μM, and values in between.

In certain embodiments of the present application, the flavor composition is admixed with a pet food product wherein the flavor composition is present in an amount of from about 10 nM to about 0.5 M, or from about 1 nM to about 0.5 M, or from about 0.1 nM to about 0.5 M, and values in between.

In certain embodiments of the present application, the flavor composition is admixed with a pet food product wherein the flavor composition is present in an amount of from about 10 nM to about 0.1 M, or from about 1 nM to about 0.1 M, or from about 0.1 nM to about 0.1 M, and values in between.

In certain embodiments of the present application, the flavor composition is admixed with a food product wherein the flavor composition is present in an amount of from about 0.0001 to about 10% weight/weight (w/w) of the food product. For example, but not by way of limitation, the flavor composition can be present in the amount from about 0.0001% to about 10%, from about 0.0001% to about 1%, from about 0.0001% to about 0.1% , from about 0.0001 to about 0.01%, from about 0.0001% to about 0.001%, from about 0.001% to about 10%, from about 0.001% to about 1%, from about 0.01% to about 1% or from about 0.1% to about 1%, and values in between.

In certain embodiments of the present application, the flavor composition is admixed with a food product wherein the flavor composition is present in an amount of from about 0.0001% to about 5%, or from about 0.001% to about 5%, from about 0.01% to about 5% w/w, or from about 0.1% to about 5% w/w, and values in between.

In certain embodiments of the present application, the flavor composition is admixed with a food product wherein the flavor composition is present in an amount of from about 0.0001% to about 1%, or from about 0.001% to about 1%, from about 0.01% to about 1% w/w, or from about 0.1% to about 1% w/w, and values in between.

In certain embodiments of the present application, the flavor composition is admixed with a food product wherein the flavor composition is present in an amount of from about 0.001% to about 10% w/w.

### 6. Delivery Systems

In certain embodiments, the flavor compositions of the present application can be incorporated into a delivery system for use in pet food products. Delivery systems can be a non-aqueous liquid, solid, or emulsion. Delivery systems are generally adapted to suit the needs of the flavor composition and/or the pet food product into which the flavor composition will be incorporated.

The flavoring compositions can be employed in non-aqueous liquid form, dried form, solid form and/or as an emulsion. When used in dried form, suitable drying means such as spray drying can be used. Alternatively, a flavoring composition can be encapsulated or absorbed onto water insoluble materials. The actual techniques for preparing such dried forms are well-known in the art, and can be applied to the presently disclosed subject matter.

The flavor compositions of the presently disclosed subject matter can be used in many distinct physical forms well known in the art to provide an initial burst of taste, flavor and/or texture; and/or a prolonged sensation of taste, flavor and/or texture. Without being limited thereto, such physical forms include free forms, such as spray dried, powdered, and beaded forms, and encapsulated forms, and mixtures thereof.

In certain embodiments, the compounds/peptides of a flavor composition can be generated during the processing of a pet food product, e.g., sterilization, retorting and/or extrusion, from precursor compounds present in the pet food product.

In certain embodiments, as noted above, encapsulation techniques can be used to modify the flavor systems. In certain embodiments, flavor compounds, flavor components or the entire flavor composition can be fully or partially encapsulated. Encapsulating materials and/or techniques can be selected to determine the type of modification of the flavor system.

In certain embodiments, the encapsulating materials and/or techniques are selected to improve the stability of the flavor compounds, flavor components or flavor compositions; while in other embodiments the encapsulating materials and/or techniques are selected to modify the release profile of the flavor compositions.

Suitable encapsulating materials can include, but are not limited to, hydrocolloids such as alginates, pectins, agars, guar gums, celluloses, and the like, proteins, polyvinyl acetate, polyethylene, crosslinked polyvinyl pyrrolidone, polymethylmethacrylate, polylactidacid, polyhydroxyalkanoates, ethylcellulose, polyvinyl acetatephthalate, polyethylene glycol esters, methacrylicacid-co-methylmethacrylate, ethylene-vinylacetate (EVA) copolymer, and the like, and combinations thereof. Suitable encapsulating techniques can include, but are not limited to, spray coating, spray drying, spray chilling, absorption, adsorption, inclusion complexing (e.g., creating a flavor/cyclodextrin complex), coacervation, fluidized bed coating or other process can be used to encapsulate an ingredient with an encapsulating material.

Encapsulated delivery systems for flavoring agents or sweetening agents can contain a hydrophobic matrix of fat or wax surrounding a sweetening agent or flavoring agent core. The fats can be selected from any number of conventional materials such as fatty acids, glycerides or poly glycerol esters, sorbitol esters, and mixtures thereof. Examples of fatty acids include but are not limited to hydrogenated and partially hydrogenated vegetable oils such as palm oil, palm kernel oil, peanut oil, rapeseed oil, rice bran oil, soybean oil, cottonseed oil, sunflower oil, safflower oil and combinations thereof. Examples of glycerides include, but are not limited to, monoglycerides, diglycerides and triglycerides.

Waxes can be chosen from the group consisting of natural and synthetic waxes and mixtures thereof. Non-limiting examples include paraffin wax, petrolatum, carbowax, microcrystalline wax, beeswax, carnauba wax, candellila wax, lanolin, bayberry wax, sugarcane wax, spermaceti wax, rice bran wax, and mixtures thereof.

The fats and waxes can be use individually or in combination in amounts varying from about 10% to about 70%, and alternatively in amounts from about 30% to about 60%, by weight of the encapsulated system. When used in combination, the fat and wax can be present in a ratio from about 70:10 to about 85:15, respectively.

Typical encapsulated flavor compositions, flavoring agent or sweetening agent delivery systems are disclosed in U.S. Pat. Nos. 4,597,970 and 4,722,845, the disclosures of which are incorporated herein by reference in their entireties.

Liquid delivery systems can include, but are not limited to, systems with a dispersion of the flavor compositions of the present application, such as in carbohydrate syrups and/or emulsions. Liquid delivery systems can also include extracts where the compound and/or the flavor compositions are solubilized in a solvent. Solid delivery systems can be created by spray drying, spray coating, spray chilling, fluidized bed drying, absorption, adsorption, coacervation, complexation, or any other standard technique. In some embodiments, the delivery system can be selected to be compatible with or to function in the edible composition. In certain embodiments, the delivery system will include an oleaginous material such as a fat or oil. In certain embodiments, the delivery system will include a confectionery fat such as cocoa butter, a cocoa butter replacer, a cocoa butter substitute, or a cocoa butter equivalent.

When used in dried form, suitable drying means such as spray drying can be used. Alternatively, a flavoring composition can be adsorbed or absorbed onto substrates, such as water insoluble materials, and can be encapsulated. The actual techniques for preparing such dried forms are well known in the art.

### 7. Pet Food Products

The flavor compositions of the present disclosed subject matter can be used in a wide variety of pet food products. Non-limiting examples of suitable pet food products include wet food products, dry food products, moist food products, pet food supplements (e.g., vitamins), pet beverage products, snack and treats as described herein.

The combination of the flavoring composition(s) of the presently disclosed subject matter together with a pet food product and optional ingredients, when desired, provides a flavoring agent that possesses unexpected taste and imparts, for example, a kokumi sensory experience, for example, through an increase in activity of a calcium-sensing receptor. The flavor compositions disclosed herein can be added prior to, during or after formulation processing or packaging of the pet food product, and the components of the flavor composition can be added sequentially or simultaneously. In certain embodiments, the compounds/peptides of a flavor composition can be generated during the processing of a pet food product, e.g., sterilization, retorting and/or extrusion, from precursor compounds present in the pet food product.

In certain embodiments, the pet food product is a nutritionally complete dry food product. A dry or low moisture-containing nutritionally-complete pet food product can comprise less than about 15% moisture, and include from about 10 to about 60% fat, from about 10% to about 70% protein and from about 30% to about 80% carbohydrates, e.g., dietary fiber and ash.

In certain embodiments, the pet food product is a nutritionally complete wet food product. A wet or high moisture-containing nutritionally-complete pet food product can comprise greater than about 50% moisture. In certain embodiments, the wet pet food product includes from about 40% fat, from about 50% protein and from about 10% carbohydrates, e.g., dietary fiber and ash.

In certain embodiments, the pet food product is a nutritionally complete moist food product. A moist, e.g., semi-moist or semi-dry or soft dry or soft moist or intermediate or medium moisture containing nutritionally-complete pet food product comprises from about 15% to about 50% moisture.

In certain embodiments, the pet food product is a pet food snack product. Non-limiting examples of pet food snack products include snack bars, pet chews, crunchy treats, cereal bars, snacks, biscuits and sweet products.

In certain embodiments, the protein source can be derived from a plant source, such as lupin protein, wheat protein, soy protein and combinations thereof. Alternatively or additionally, the protein source can be derived from a variety of animal sources. Non-limiting examples of animal protein include beef, pork, poultry, lamb, or fish including, for example, muscle meat, meat byproduct, meat meal or fish meal.

### 8. Methods of Measuring Taste Attributes

In certain embodiments of the present disclosure, the taste, flavor and/or palatability attributes of a pet food product can be modified by admixing a flavor composition with the food product, or generated under food preparation conditions, as described herein. In certain embodiments, the attribute(s) can be enhanced or reduced by increasing or decreasing the concentration of the flavor composition admixed or generated with the food product. In certain embodiments, the taste attributes of the modified food product can be evaluated as described herein, and the concentration of flavor composition admixed or generated with the food product can be increased or decreased based on the results of the evaluation.

In certain embodiments of the present disclosure, the taste and/or palatability attributes can be measured using an in vitro assay, wherein the ability of a compound (e.g., a peptide) to activate a feline calcium-sensing receptor expressed by cells in vitro at different concentrations is measured. In certain embodiments, an increase in the activation of the receptor correlates with an increase in the taste and/or palatability attributes of the compound. In certain embodiments, the composition is measured alone or in combination with other compounds. In certain embodiments the in vitro assay comprises the in vitro assays described in the Examples section of the present application.

In certain embodiments of the present disclosure, the taste and/or palatability attributes can be measured using an in silico model, wherein a compound's ability to interact with amino acid residues in a binding site of a calcium-sensing receptor is determined in silico. In certain embodiments, a compound's ability to modulate a feline calcium-sensing receptor correlates with the degree of binding of the compound to a model of the receptor in silico. In certain embodiments, the composition is measured alone or in combination with other compounds. In certain embodiments the in silico model comprises the in silico models described in the Examples section of the present application.

In certain embodiments of the present disclosure, the taste and/or palatability attributes can be measured using a panelist of taste testers. For example, but not by way of limitation, the panel can contain feline panelists. In certain embodiments, the panel can include canine panelists. In certain embodiments, the palatability of a pet food product can be determined by the consumption of a pet food product containing a flavor composition alone (e.g., the one bowl test, monadic ranking). In certain embodiments, the palatability of a pet food product can be determined by the preferential consumption of a pet food product containing a flavor composition, disclosed herein, versus a pet food product that does not contain the flavor composition or another flavor composition (e.g., the two bowl test for testing preference, difference and/or choice).

In certain embodiments, the palatability and/or kokumi taste of a flavor composition can be determined by the preferential consumption of a water solution containing a flavor composition, disclosed herein, versus a water solution that does not contain the flavor composition or contains a different flavor composition (e.g., the two bottle test). For example, a solution panel can be used to compare the palatability of a range of concentrations of compounds in a monadic exposure. In certain embodiments, the solution can contain a palatability enhancer, for example, L-histidine, as an ingestive/positive tastant to increase baseline solution intake, therefore enabling the identification of a potential negative impact of the test compound.

The intake ratio for each pet food product or emulsion can be determined by measuring the amount of one ration consumed divided by the total consumption. The consumption ratio (CR) can then be calculated to compare the consumption of one ration in terms of the other ration to determine the preferential consumption of one food product or emulsion over the other. Alternatively or additionally, the difference in intake (g) can be used to assess the average difference in intake between the two emulsions in a two bottle test or between two pet food products in a two bowl test at a selected significance level, for example, at the 5% significance level to determine an average difference in intake with a 95% confidence interval. However, any significance level can be used, for example, a 1%, 2%, 3%, 4%, 5%, 10%, 15%, 20%, 25%, or 50% significance level. In certain embodiments, percentage preference scores, e.g., the percentage preference for one emulsion or food product by an animal is the percentage of the total emulsion or food product ingested during the test that that emulsion or food product accounts for, can also be calculated.

### 9. Methods of Manufacture

In certain embodiments, the compounds (e.g., peptides) of the present disclosure can be manufactured using standard chemosynthesis processes. In certain embodiments, the chemosynthesis process provides a compound having a purity of at least 99.999%, or at least 99%, or at least 95%, or at least 90%, or at least 85 or at least 80%. In certain embodiments, the compounds can be prepared using standard hydrolysis processes such as those employing acids, enzymes or a combination of acids and enzymes.

In certain embodiments, the compounds of the present disclosure can be manufactured under food preparation conditions, e.g., during the production of a pet food product. For example, but not by way of limitation, the compounds of the present disclosure can be generated during a thermal food process, e.g., sterilization, retorting and/or extrusion, from precursor compounds present in the pet food. In certain embodiments, a liquid and/or a powder palatant can also be added to enhance the taste of a pet food, e.g., to a dry pet food product, and to increase the palatability of the pet food. The palatant can be a digest of meat (e.g., liver) and/or a digest of a vegetable, and can optionally include other palatants known in the art. In certain embodiments, the compound can be admixed with or generated in the liquid and/or powder palatant prior to its addition to the pet food product. Alternatively, or additionally, the compound can be admixed with or generated in the liquid and/or powder palatant after its addition to the pet food product.

### 10. Non-limiting Examples of Methods of the Present Disclosure

In certain non-limiting embodiments, the present disclosure provides for a method of increasing the palatability of a pet food product comprising admixing the pet food product with a flavor composition comprising a peptide as described herein, wherein the peptide is present at a concentration of from about 1 nM to about 10 M, or from about 1 nM to about 1 M in the admixture.

In certain non-limiting embodiments, the present disclosure provides for a method of increasing the palatability of a pet food product comprising producing the pet food product with a flavor composition comprising a peptide as described herein, wherein the peptide is present at a concentration of from about 1 nM to about 10 M, or from about 1 nM to about 1 M in the product.

In certain non-limiting embodiments, the present disclosure provides for a method of increasing the kokumi taste of a pet food product, for example, by increasing the activity of a calcium-sensing receptor, comprising admixing the pet food product with a flavor composition comprising a peptide as described herein, wherein the peptide is present at a concentration of from about 0.001 ppm to about 1,000 ppm in the admixture.

In certain non-limiting embodiments, the present disclosure provides for a method of increasing the palatability of a pet food product comprising admixing the pet food product with a flavor composition comprising a peptide as described herein, wherein the flavor composition is present at a concentration of from about 0.001 ppm to about 1,000 ppm in the admixture.

In certain non-limiting embodiments, the present disclosure provides for a method of increasing the kokumi taste of a pet food product, for example, by increasing the activity of a calcium-sensing receptor, comprising admixing the pet food product with a flavor composition comprising a peptide as described herein, wherein the flavor composition is present at a concentration of from about 0.0001% to about 10% w/w, or from about 0.001% to about 5% w/w, or from about 0.01% to about 1% w/w in the admixture.

In certain non-limiting embodiments, the present disclosure provides for a method of increasing the palatability of a pet food product comprising admixing the pet food product with a flavor composition comprising a peptide as described herein, wherein the flavor composition is present at a concentration of from about 0.0001% to about 10% w/w, or from about 0.001% to about 5% w/w, or from about 0.01% to about 1% w/w in the admixture.

### EXAMPLES

The presently disclosed subject matter will be better understood by reference to the following Examples, which are provided as exemplary of the invention, and not by way of limitation.

### Example 1—Production and Testing of Caseinate Hydrolysates

The present example investigated the use of protein hydrolysates palatants systems for wet cat food.

Milk proteins (caseinate) were hydrolyzed at different enzyme conditions. A total of 14 hydrolysates were produced. Degree of hydrolysis in bulk samples varied between 8% and 35%, and the dry matter varied between 4 and 8%. All bulk samples were of food grade quality.

Five different hydrolysates and a control casein hydrolysate were selected for animal feeding tests. The conditions of each hydrolysates are listed in Table 1.

TABLE 1

| | | Hydrolysis | Target | Actual | |
|---|---|---|---|---|---|
| Code | Variant | Time | DH % | DH % | |
| T273 | Casein hydrolysate | — | — | 44 | |
| | (Sigma) | | | | |
| T647 | Protamex + Protease | Half-6 h | 16.5 | 21 | LOW |
| | M (Sequential) | | | | |
| T648 | Protamex + Protease | Full - 24 h | 33 | 34 | HIGH |
| | M (Sequential) | | | | |
| T649 | Protamex + Protease | Half - 2.5 h | 18 | 15 | LOW |
| | M (Combined) | | | | |
| T650 | Protamex + Protease | Full 23 h | 36 | 41 | HIGH |
| | M (Combined) | | | | |
| T651 | Protamex + MaxiPro | Full - 18 h | 18 | 17 | LOW |
| | (Combined) | | | | |

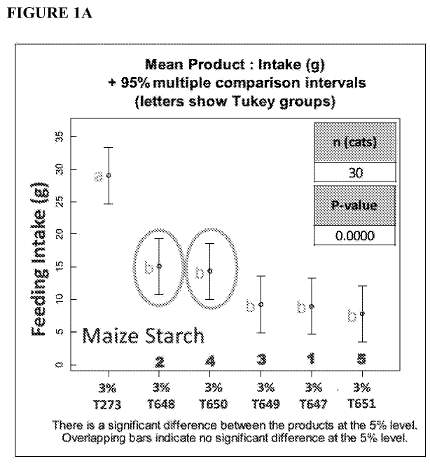

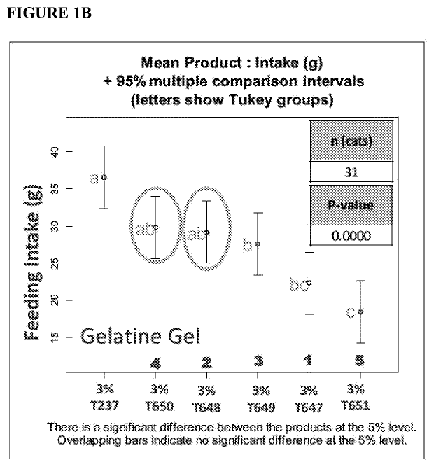

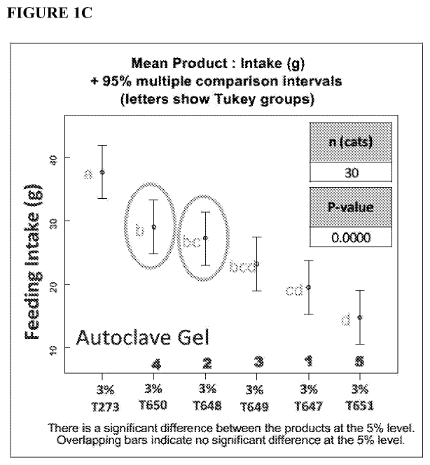

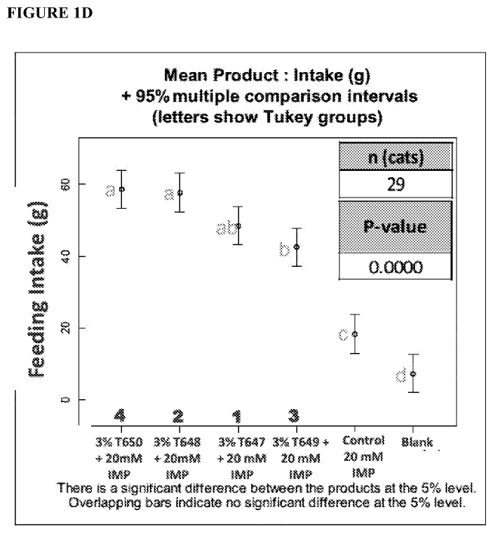

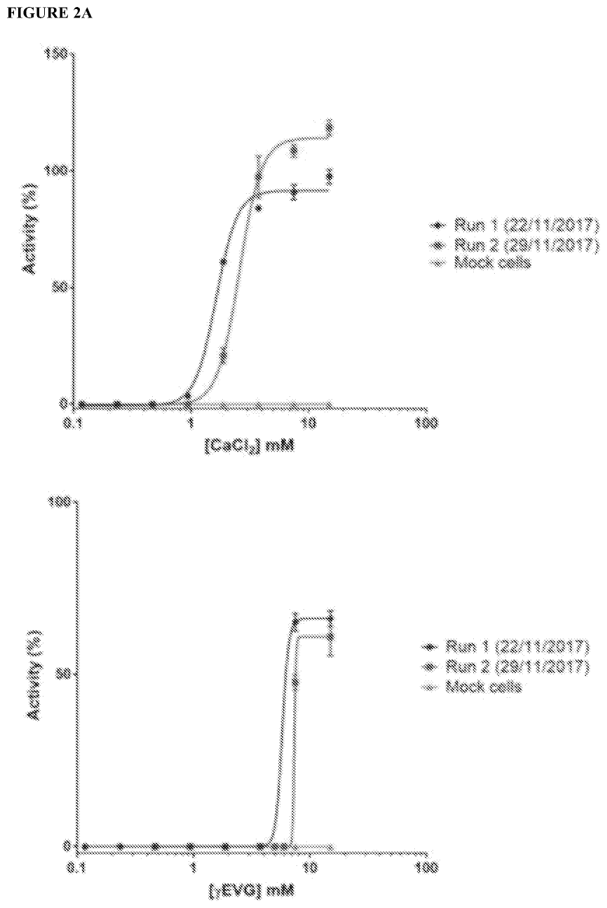

Animal feeding tests were conducted where each hydrolysate was mixed in different matrices (maize gravy, gelatine and autoclave gels) at 3%. Similar patterns of food intake among different hydrolysates were observed in all three matrices as shown in FIGS. 1A-1C. Feeding test was repeated in gelatine gel with 20 mM IMP to boost intakes. A similar pattern of food intake was observed as shown in FIG. 1D. Hydrolysate T648 was selected for further testing as it had the highest intake across different matrices.

### Example 2—Separation and Identification of Bioactive Compounds from Hydrolysate

The present example describes the identification of potentially taste active peptides from casein hydrolysates showing increased palatability in wet cat food.

Hydrolysate T648 was analyzed by activity-guided fractionation (AGF) using standard methods known to the field. Briefly, isolation of the putative bioactive compounds (BCs) from the hydrolysate was conducted by a combination of different separation techniques, e.g., medium pressure liquid chromatography (MPLC), size exclusion chromatography (SEC) and high pressure liquid chromatography (HPLC). Twelve nominated putative BCs were isolated from the hydrolysate, of which seven putative BCs were structurally elucidated by NMR and/or by peptide mapping using LC-ESI-MS/MS. The obtained sequences are shown in Table 2.

Aliquots of the isolated samples were tested for their agonistic activity in feline Kokumi taste receptor assays (f-CaSR). The summarized activity obtained in the assays is listed in Table 2.

TABLE 2

| | | | | f-CaSR |
|---|---|---|---|---|
| Putative | Rt | MW | | activity |
| BC | [min] | [Da] | Determined amino acid sequence | (EC50) |
| BC 01 | 1.7 | 361 | Asp-Val-Glu | 6.32 mM |
| BC 02 | 3.1 | 483 | 5-oxoproline-Lys-Glu-Pro (SEQ ID NO: 12) | Not active |
| BC 03 | 7.7 | 1301 | N/A | N/A |
| BC 04 | 9.0 | 977 | N/A | N/A |
| BC 05 | 9.1 | 655 | N/A | N/A |
| BC 06 | 9.4 | 1124 | Ile-Gly-Ser^{phospho}-Glu-Ser^{phospho}-Thr-Glu-Asp-Gln | 2 mM |
| | | | (SEQ ID NO: 7) | |
| BC 07 | 10.0 | 2701 | N/A | N/A |
| BC 08 | 10.1 | 1195 | Ile-Gly-Ser^{phospho}Glu-Ser^{phospho}-Thr-Glu-Asp-Gln-Ala | 2 mM |
| | | | (SEQ ID NO: 8) | |
| BC 09 | 10.3 | 1066 | Glu-Ile-Val-Pro-Asn-Serphospho- Ala-Glu-Glu (SEQ ID NO: 9) | 3.16 mM |
| BC 10 | 10.5 | 1310 | Asp-Ile-Gly-Ser^{phospho}-Glu-Ser^{phospho}-Thr-Glu-Asp-Gln-Ala | 2 mM |
| | | | (SEQ ID NO: 10) | |
| BC 11 | 11.0 | 1057 | N/A | N/A |

### Example 3—In Silico Modeling for Identifying Compounds that Interact with CaSR

The present example describes the computational modeling of the feline calcium-sensing receptor (CaSR) to identify putative agonists.

Computational approaches were used to analyze the three-dimensional structure of CaSR to identify polypeptide regions that can be exploited to selectively activate the receptor. A structural homology model of the Venus flytrap and cysteine-rich domains of the CaSR were generated based on crystal structures of human CaSR (Geng, et al. 2016; Zhang, et al. 2016). The homology models were built with the Discovery Studio (DS) suite of programs from Accelrys. Specifically, the Modeller program from DS was used (see Eswar et al., Current Protocols in Bioinformatics, Supplement 15:5.6.1-5.6.30 (2006), which is incorporated by reference herein in its entirety). “In silico” screening was used to identify compounds that interact with the structural domains of CaSR.

The GPCR group C family of proteins includes T1R1, T1R2, T1R3, CaSR, GabaB and mGlu proteins. Group C proteins have (1) a large external domain, called a Venus Flytrap (VFT) domain, (2) a 7 Transmembrane (7TM) domain and (3) a cysteine rich domain that connects the VFT and the 7TM domains. A homology model of the VFT and cysteine rich domain of the feline CaSR receptor was generated based on the recent crystal structures of hCaSR (Geng, et al. 2016; Zhang, et al. 2016) that are now available from the Protein Data Bank (PDB, www.rcsb.org). The docking program, BioDock, from BioPredict was used to dock the compounds, including Asp-Val-Glu and γ-Glu-Val-Gly, into the active site of the VFT domain of CaSR, in silico, as shown in FIG. 3A-3C.

Residues lining the active site of feline CaSR Venus Flytrap domain include: Pro39, Asn64, Arg66, Gly67, Arg69, Trp70, Asn102, Thr145, Gly146, Ser147, Gly148, Tyr167, Ala168, Ser169, Ser170, Ser171, Ile187, Tyr218, Ser271, Ser272, Glu297, Ala298, Trp299, Ala300, Ser301, Ser302, and Ile416. In particular, Arg66, Trp70, Thr145, Ser147, Ala168, Ser170, Tyr218, Ser272, Glu297, and Ile416 played roles in the homology models by forming salt-bridges, hydrogen-bonding and hydrophobic interactions to coordinate the negatively charged head-groups and polar parts of compounds bound to the active site.

### Example 4—Identification of Active Motif of CaSR-Active Peptides

Based on structural analyses of the kokumi active peptides identified in Example 2 and the in silico modeling described in Example 3, the following tripeptide motif was predicted as a “kokumi-active motif” that can activate a CaSR receptor:

[Negatively charged or polar amino acid]-[an amino acid that has a molecular mass of no more than 150 Dalton]-[Negatively charged or polar amino acid].

Based on this active motif, 12 additional peptides were predicted to activate CaSR. The complete list of these 12 peptides alone with two active peptides, Asp-Val-Glu and Asp-Ile-Gly-pSer-Glu-pSer-Thr-Glu-Asp-Ala (SEQ ID NO: 11), are described in Table 3.

TABLE 3

| Pep- | |
|---|---|
| tide | |
| Se- | |
| quence | Peptide Structure |
| Asp- Ile- Gly- pSer- Glu- pSer- Thr- Glu- Asp- Ala (SEQ ID NO: 11) | 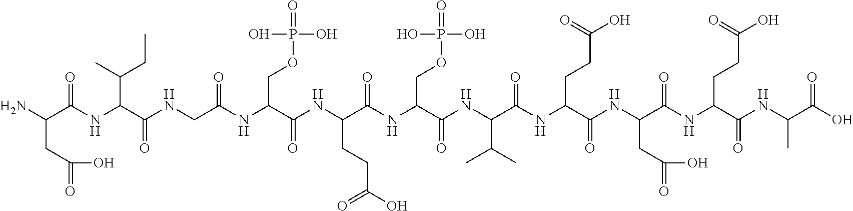 [SMILES: CCC(C)C(NC(=O)C(N)CC(=O)O)C(=O)NCC(=O)NC(COP(=O)(O)O)C(=O)NC(CCC(=O)O)C(=O)NC(COP(=O)(O)O)C(=O)NC(C(=O)NC(CCC(=O)O)C(=O)NC(CC(=O)O)C(=O)NC(CCC(=O)O)C(=O)NC(C)C(=O)O)C(C)C] |
| pSer- Glu- pSer | 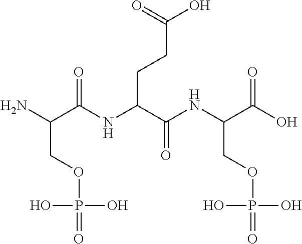 [SMILES: NC(COP(=O)(O)O)C(=O)NC(CCC(=O)O)C(=O)NC(COP(=O)(O)O)C(=O)O] |
| pSer- Val- pSer | 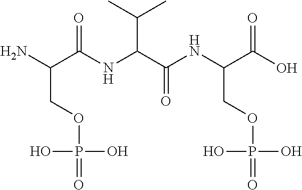 [SMILES: CC(C)C(NC(=O)C(N)COP(=O)(O)O)C(=O)NC(COP(=O)(O)O)C(=O)O] |
| pSer- Val- Glu | 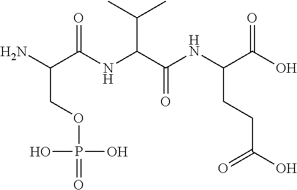 [SMILES: CC(C)C(NC(=O)C(N)COP(=O)(O)O)C(=O)NC(CCC(=O)O)C(=O)O] |
| pTyr- GLu- pTyr | 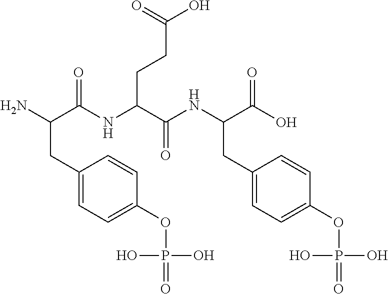 [SMILES: NC(Cc1ccc(OP(=O)(O)O)cc1)C(=O)NC(CCC(=O)O)C(=O)NC(Cc1ccc(OP(=O)(O)O)cc1)C(=O)O] |
| pThr- Glu- pThr | 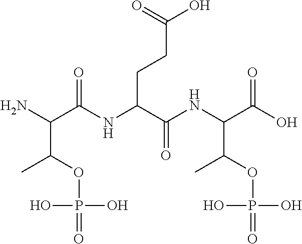 [SMILES: CC(OP(=O)(O)O)C(N)C(=O)NC(CCC(=O)O)C(=O)NC(C(=O)O)C(C)OP(=O)(O)O] |
| Ser- Glu- Ser | 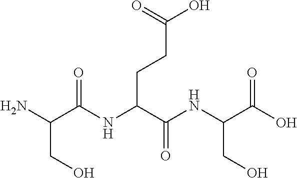 [SMILES: NC(CO)C(=O)NC(CCC(=O)O)C(=O)NC(CO)C(=O)O] |
| Asp- Val- Glu | 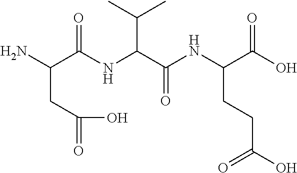 [SMILES: CC(C)C(NC(=O)C(N)CC(=O)O)C(=O)NC(CCC(=O)O)C(=O)O] |
| Asp- Val- Asp | 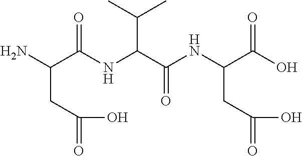 [SMILES: CC(C)C(NC(=O)C(N)CC(=O)O)C(=O)NC(CC(=O)O)C(=O)O] |
| Glu- Val- Glu | 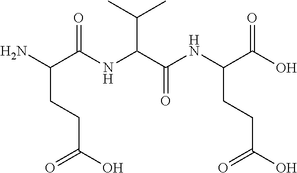 [SMILES: CC(C)C(NC(=O)C(N)CCC(=O)O)C(=O)NC(CCC(=O)O)C(=O)O] |
| Asp- Ala- Glu | 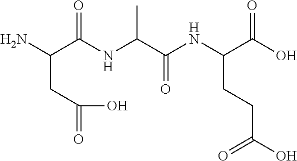 [SMILES: CC(NC(=O)C(N)CC(=O)O)C(=O)NC(CCC(=O)O)C(=O)O] |
| Asp- Glu- Glu | 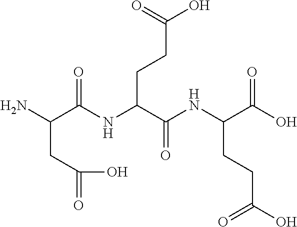 [SMILES: NC(CC(=O)O)C(=O)NC(CCC(=O)O)C(=O)NC(CCC(=O)O)C(=O)O] |
| Glu- Val- Asp | 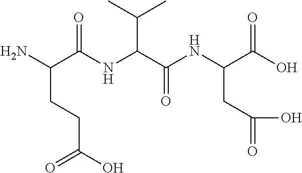 [SMILES: CC(C)C(NC(=O)C(N)CCC(=O)O)C(=O)NC(CC(=O)O)C(=O)O] |
| Cys- Val- Cys | 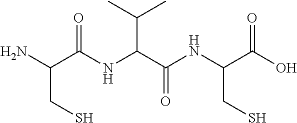 [SMILES: CC(C)C(NC(=O)C(N)CS)C(=O)NC(CS)C(=O)O] |

### Example 5—In Vitro Testing of Predicted CaSR-Active Peptides

The 14 peptides listed in Table 3, along with a number of control peptides and compounds were tested in vitro to evaluate their abilities to activate a feline CaSR.

### Methods

The cells used for the assays were HEK293 derived HEK T-Rex/natClytin-fCaSR cells. For the assays, the cells were plated on 386-well culture plates with a clear bottom for reading the luminescence in the wells. The setup of the assay for standard assays on the FlexStation was as follows. The wells containing the cells had 20 ul of calcium-free Tyrode's buffer at the beginning of the assay. 20 ul of each ligand at a specified concentration was injected on the cells and the response of the cells was measured for 90 sec at 1.94 sec intervals. The resulting curves were analyzed and reduced using the software provided by Molecular Devices, SoftMax Pro (version 5.4.1).

Each peptide was assayed on two separate occasions at least, with four repetitions of each concentration applied to the cells. In parallel, the same tests were run on a mock cell line with a mock vector, in order to confirm the specificity of any signals measured.

The data obtained from the FlexStation was used to trace dose-response curves for each ligand. These graphs were plotted using GraphPad Prism 7.03 software with the [Agonist] vs. response—Variable slope (four parameters) plot. The same formula was used to calculate the EC50 value with the associated Standard Error. Each plot contains the mean data points with an SEM calculated by the software for each data point.

One of the concerns during the planning of these assays was that it was possible that some of these peptides could bind the divalent calcium cation and cause a non-specific response from the receptor. In order to ensure that the interaction between the receptor and the peptides was measured and not with calcium, the peptides were synthesized in guaranteed calcium-free conditions. Similarly, all the assays were performed using calcium-free reagents.

### Results

### 1. All Predicted Kokumi-Active Peptides Activate Cat CaSR In Vitro

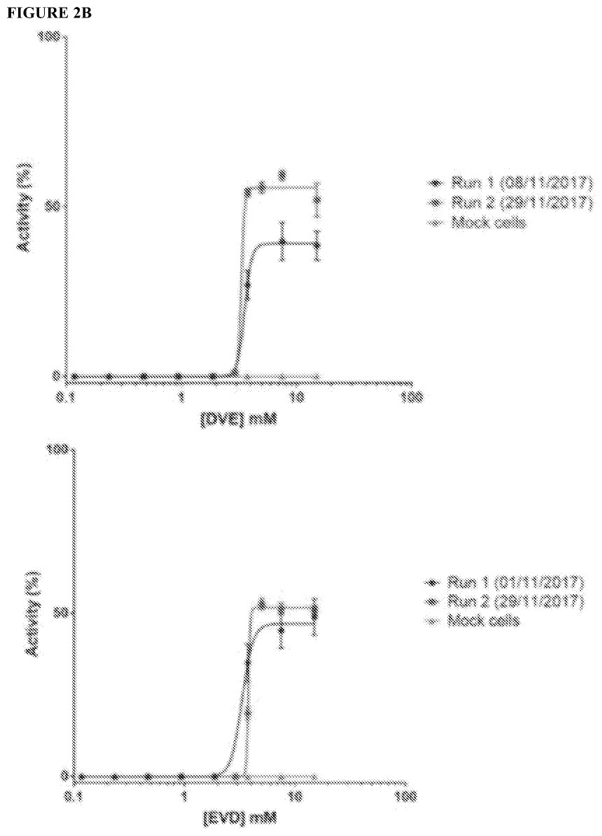

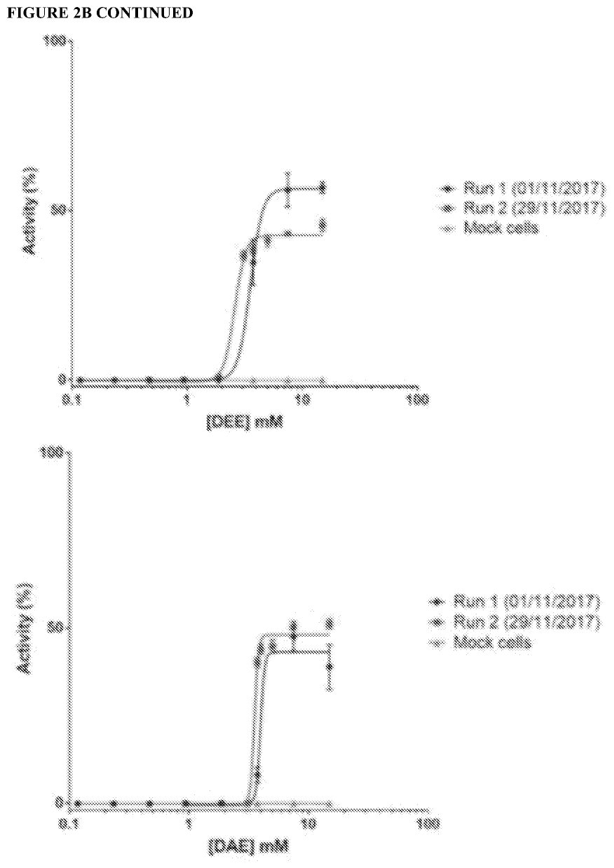

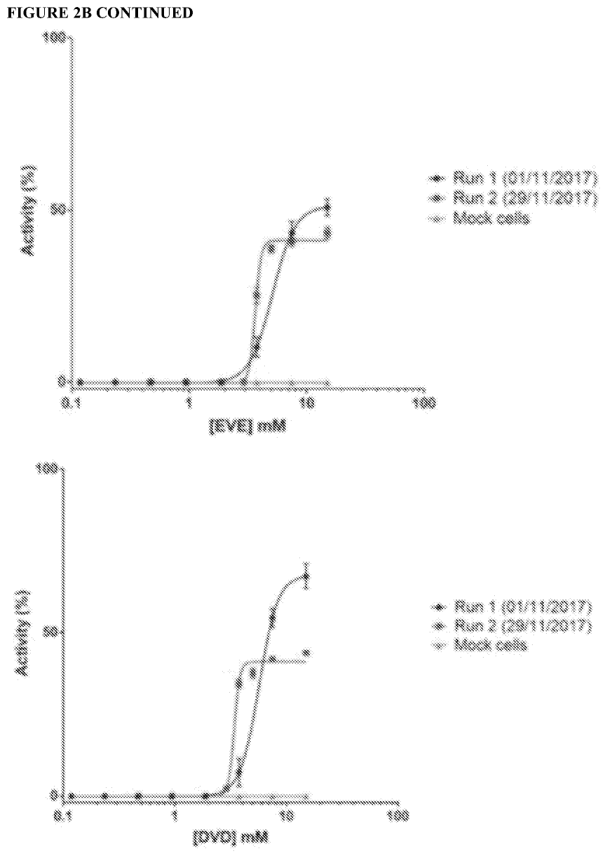

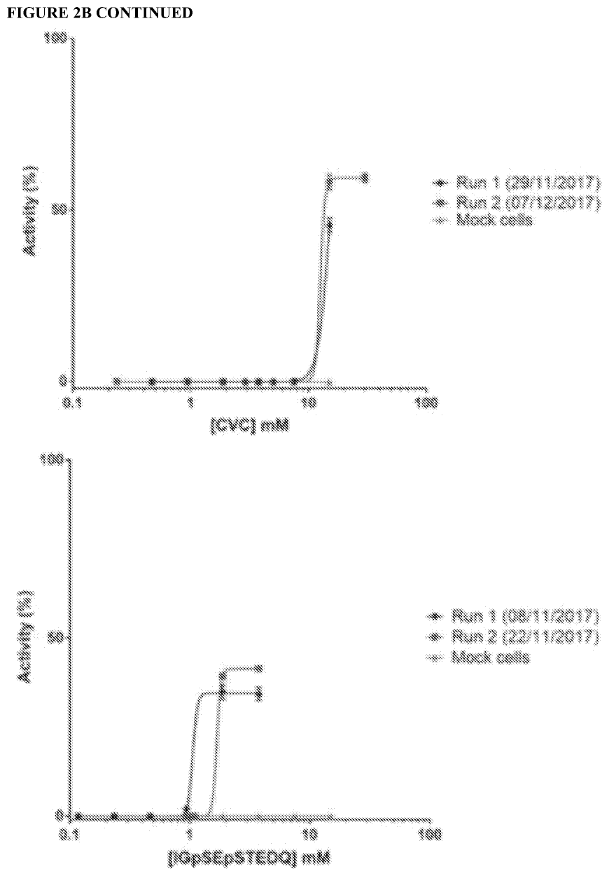

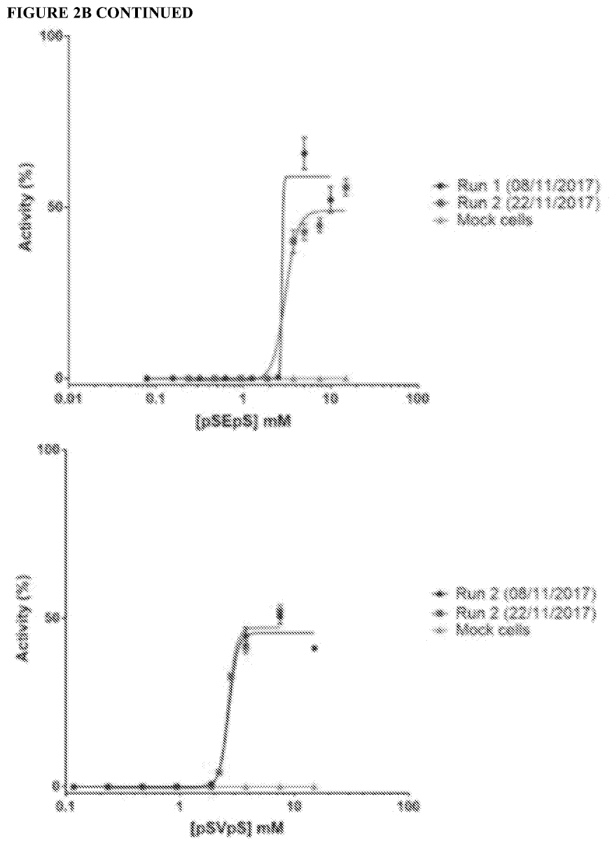

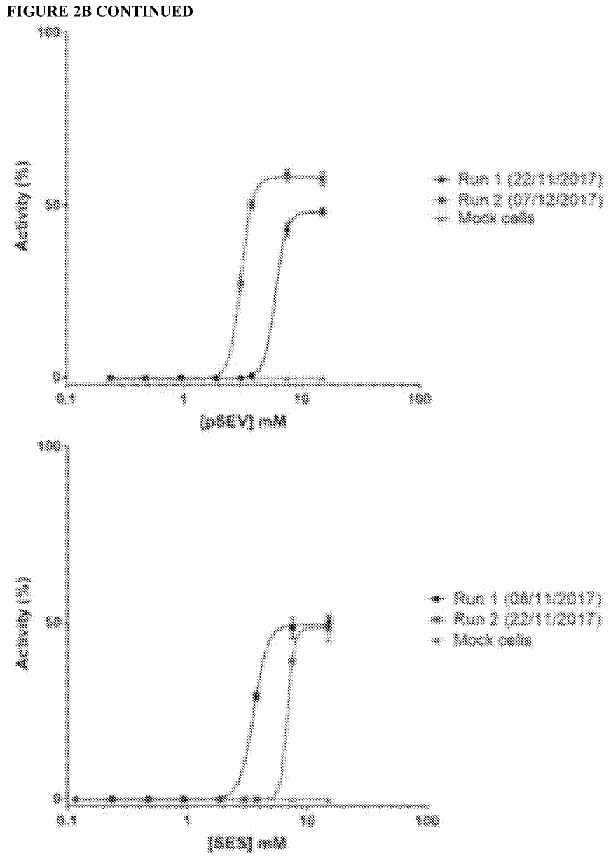

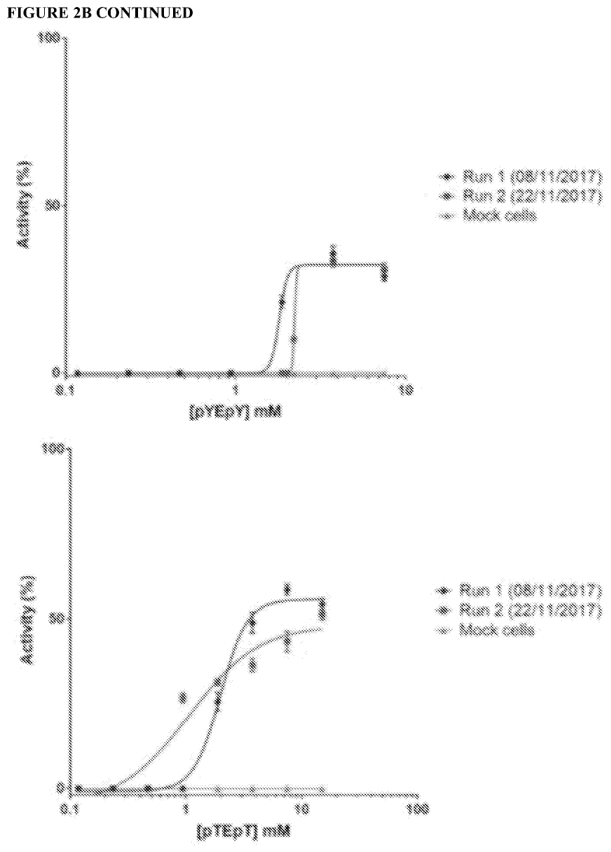

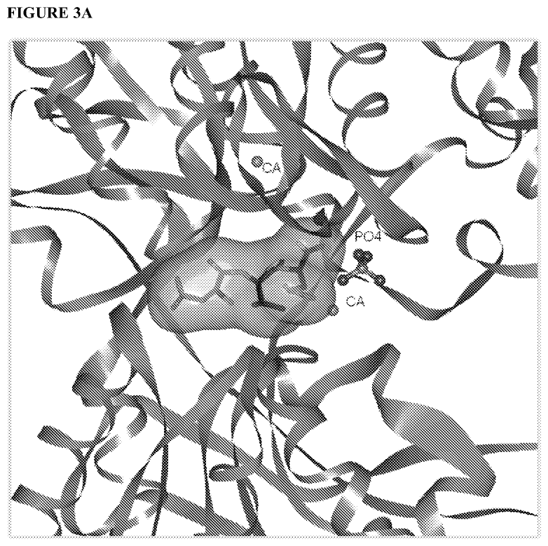

The positive controls for the assay were CaCl₂ and the previously described kokumi peptide γ-Glu-Val-Gly (FIG. 2A). On all the graphs, two separate runs are shown with one mock cell run (no mock cell response was recorded for any of the ligands). All other ligands were assayed in a similar manner and the data obtained are detailed in FIG. 2B and Table 4.

TABLE 4

| | Molecular | Highest | EC50 ± Std | |
|---|---|---|---|---|
| Compound | mass | concentration | Error | |
| CaC12 | 110.9 | 15 mM | 1.6 ± 0.06 | mM |
| MgC12 | 95.2 | 30 mM | 6.72 ± 0.13 | mM |
| GSH | 307.3 | 30 mM | 6.71 ± 0.57 | mM |
| γ-Glu-Val-Gly | 303.3 | 15 mM | 5.78 ± 2.41 | mM |
| Asp | 133.1 | 20 mM | ≈6.1 | mM |
| Glu | 147.1 | 20 mM | ≈5.9 | mM |
| Ile-Gly-pSer-Glu-pSer-Thr-Glu-Asp-Gln | 1124.3 | 15 mM | ≈1.6 | mM |
| Asp-Val-Glu | 361.1 | 15 mM | 3.3 ± 0.15 | mM |
| Glu-Val-Asp | 361.1 | 15 mM | 3.32 ± 0.77 | mM |
| Asp-Glu-Glu | 391.1 | 15 mM | 2.59 ± 0.09 | mM |
| pSer-Glu-pSer | 481.1 | 15 mM | 3.04 ± 0.21 | mM |
| pSer-Val-pSer | 451.1 | 15 mM | 2.63 ±0.04 | mM |
| pSer-Val-Glu | 413.1 | 15 mM | 3.04 ±0.03 | mM |
| Ser-Glu-Ser | 321.1 | 15 mM | 3.56± 0.11 | mM |
| Cys-Val-Cys | 323.1 | 30 mM | ≈12.56 | mM |
| pTyr-Glu-pTyr | 633.2 | 15 mM | 2.22 ± 0.22 | mM |
| pThr-Glu-pThr | 509.1 | 15 mM | 1.98 ± 0.07 | mM |
| Asp-Ala-Glu | 333.3 | 15 mM | 3.54 ±0.05 | mM |
| Glu-Val-Glu | 375.2 | 15 mM | 3.54 ±0.05 | mM |
| Asp-Val-Asp | 347.1 | 15 mM | 3.41 ±0.05 | mM |
| γ-Glu-Val | 246.3 | 30 mM | ≈3.9 | mM |
| γ-Glu-Met | 278.3 | 30 mM | ≈6.7 | mM |
| γ-Glu-Phe | 294.3 | 30 mM | ≈7.8 | mM |
| γ-Glu-Tyr | 310.3 | 30 mM | ≈6.9 | mM |

All of the 12 predicted kokumi peptides activate the cat CaSR receptor at a millimolar range concentration. Although there are slight differences between the apparent affinities of the same ligand between runs, the differences are minor and within acceptable range. The affinities of all the peptides are detailed in Table 4. For some of the peptides, the model used to calculate the EC50 value provided an estimate rather than exact data, and therefore no standard error was associated to these values.

Although the presently disclosed subject matter and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the presently disclosed subject matter, processes, machines, manufacture, compositions of matter, means, methods, or steps, presently existing or later to be developed that perform substantially the same function or achieve substantially the same result as the corresponding embodiments described herein can be utilized according to the presently disclosed subject matter. Accordingly, the appended claims are intended to include within their scope such processes, machines, manufacture, compositions of matter, means, methods, or steps.

Patents, patent applications, publications, product descriptions and protocols are cited throughout this application the disclosures of which are incorporated herein by reference in their entireties for all purposes.

1. A flavor composition comprising an oligopeptide comprising a tripeptide motif that comprises:
(a) a first amino acid residue at the N-terminus that is a negatively charged amino acid residue or a polar, uncharged amino acid residue;
(b) a second amino acid residue that has a molecular mass of no more than 150 Dalton; and
(c) a third amino acid residue at the C-terminus that is a negatively charged amino acid residue or a polar, uncharged amino acid residue;
wherein the tripeptide motif binds to a calcium-sensing receptor (CaSR) to impart a kokumi taste to a companion animal.

2. The flavor composition of claim 1, wherein the first amino acid residue and the third amino acid residue are negatively charged amino acid residues.

3. (canceled)

4. The flavor composition of claim 2, wherein the negatively charged amino acid residues are selected from the group consisting of aspartic acid (Asp), glutamic acid (Glu), phosphorylated serine (pSer), phosphorylated tyrosine (pTyr), and phosphorylated threonine (pThr).

5. (canceled)

6. The flavor composition of claim 1, wherein the first amino acid residue and the third amino acid residue are polar, uncharged amino acid residues.

7. (canceled)

8. The flavor composition of claim 6, wherein the polar, uncharged amino acid residues are selected from the group consisting of cysteine (Cys), glycine (Gly), glutamine (Gln), asparagine (Asp), serine (Ser), tyrosine (Tyr) and threonine (Thr).

9. The flavor composition of claim 1, wherein the second amino acid residue is selected from the group consisting of lysine (Lys), isoleucine (Ile), leucine (Leu), alanine (Ala), methionine (Met), proline (Pro), valine (Val), aspartic acid (Asp), glutamic acid (Glu), cysteine (Cys), glycine (Gly), glutamine (Gin), asparagine (Asn), serine (Ser), and threonine (Thr).

10. The flavor composition of claim 9, wherein the second amino acid residue is an alanine (Ala), a valine (Val) or a glutamic acid (Glu).

11. The flavor composition of claim 1, wherein the oligopeptide comprises a tripeptide selected from the group consisting of Asp-Val-Glu, Glu-Val-Asp, Asp-Glu-Glu, pSer-Glu-pSer, pSer-Val-pSer, pSer-Val-Glu, Ser-Glu-Ser, Cys-Val-Cys, pTyr-Glu-pTyr, pThr-Glu-pThr, Asp-Ala-Glu, Glu-Val-Glu, and Asp-Val-Asp.

12. The flavor composition of claim 1, wherein the oligopeptide is selected from the group consisting of Ile-Gly-pSer-Glu-pSer-Thr-Glu-Asp-Gln (SEQ ID NO: 7), Ile-Gly-pSer-Glu-pSer-Thr-Glu-Asp-Gln-Ala (SEQ ID NO: 8), Glu-Ile-Val-Pro-Asn-pSer-Ala-Glu-Glu (SEQ ID NO: 9), and Asp-Ile-Gly-pSer-Glu-pSer-Thr-Glu-Asp-Gln-Ala (SEQ ID NO: 10).

13. The flavor composition of claim 1, wherein the companion animal is a cat or a dog.

14. (canceled)

15. The flavor composition of claim 1, wherein the oligopeptide is generated during a manufacture process of a food product.

16. A food product comprising the flavor composition of claim 1, wherein the flavor composition is present in an amount effective to increase a kokumi taste of the food product, as determined by a panel of taste testers.

17. (canceled)

18. The food product of claim 16, wherein the flavor composition is present at a concentration of from about 0.0001% to about 10% w/w in the food product.

19. The food product of claim 16, wherein the food product comprises a pet food product.

20. The food product of claim 19, wherein the pet food product is a feline pet food product or a canine pet food product.

21. The food product of claim 19, wherein the pet food product is a wet pet food product.

22. The food product of claim 19, wherein the pet food product is a dry pet food product.

23. The food product of claim 16, wherein the flavor composition is generated during a manufacturing process of the food product.

24. A method for increasing a kokumi taste intensity in a food product comprising admixing a food product with the flavor composition of claim 1, wherein the flavor composition is present in an amount effective to increase a kokumi taste of the food product, as determined by a panel of taste testers.

25. The method of claim 24, wherein the flavor composition is present at a concentration of from about from about 0.0001% to about 10% w/w in the admixture.
